(19) United States
(12) Patent Application Publication
(10) Pub. No.: US 2011/0225097 A1
(43) Pub. Date: Sep. 15, 2011

(54) METHOD AND APPARATUS FOR VALUATION OF A RESOURCE

(75) Inventors: Paul Johnson, Manchester (GB); Sydney Dixon Howell, Birch Vale (GB); Peter Duck, Cheshire (GB); Geoffrey William Evatt, Southampton (GB); John Moriarty, Liverpool (GB)

(73) Assignee: THE UNIVERSITY OF MANCHESTER, Manchester (GB)

(21) Appl. No.: 12/952,401

(22) Filed: Nov. 23, 2010

Related U.S. Application Data
(60) Provisional application No. 61/263,525, filed on Nov. 23, 2009.

(51) Int. Cl. G06Q 10/00

(52) U.S. Cl. 705/306

(57) ABSTRACT

A computer-implemented method of valuing a resource using a computer comprising a processor and a memory storing processor readable instructions, the method comprising: storing in the memory a model representing a relationship between the economic value of the resource, a rate of extraction of the resource and a parameter indicative of a property of the resource; processing, by the processor, the model to generate an economic value of the resource, the model; wherein the model stored in the memory and processed by the processor represents variation of the property of the resource with respect to a parameter based upon a quantity of the resource.

The present invention relates to methods and apparatus for use in the valuation of a resource. More particularly, but not exclusively, the invention relates to methods for optimising the value of a resource where the value of the resource depends upon factors which include uncertainty.

Natural resources such as oil wells and mines can be valuable assets. It is a common practice amongst mining companies to acquire the right to mine natural resources, either by acquiring a natural resource outright or by acquiring a license to extract and sell a natural resource for a predetermined period of time. Such acquisitions of rights to mine natural resources can be for large sums of money and it is desirable to ensure that a profit can be made from the acquisition. As such it is desirable to accurately determine the value of a resource.

The value of a resource may depend on many different factors including the sale price of the resource, the quality of the resource, the amount of the resource that can be mined, interest rates and costs associated with extracting, storing and transporting the resource. Some of the factors on which the value of a resource depends may vary in a manner that is hard or sometimes impossible to predict. Accurate valuation of a resource can therefore be difficult.

Additionally, the value of a resource may vary depending upon factors that may be controlled. For example the rate of extraction of a resource may affect the value of the resource that may be achieved in the time allowed by a contract to mine the resource. Given the desire to ensure a profit is achieved from a resource, and given the desire to maximise the profit achieved, it is desirable to optimise factors that may be controlled such as the extraction rate. However, the dependence of a value of a resource upon many different factors, which may additionally be dependent upon each other, means that determination of optimal values of controllable factors can be difficult.

It is an object of some embodiments of the present invention to obviate or mitigate at least some of the problems set out above.

According to a first aspect of the invention there is provided a method of valuing a resource. The method comprises processing a model to generate an economic value of the resource, the model representing a relationship between the economic value of the resource, a rate of extraction of the resource and a parameter indicative of a property of the resource; wherein the model represents variation of the property of the resource with respect to a parameter based upon a quantity of the resource.

The inventors have found that representing variation of a property of a resource with respect to a parameter based upon a quantity of the resource in this way allows variation of the property of the resource to be effectively modelled. Modelling a relationship between parameters associated with a resource allows the resource to be valued and additionally can allow optimal parameter values of the model to be determined, the optimal parameter values providing an optimal value of the resource. Typically, such models include at least one stochastic parameter, that is a parameter whose value varies and cannot be properly controlled. The including of such a stochastic parameter results in the model including risk based upon the unpredictability of the stochastic parameter. The model may be made risk free using hedging techniques to hedge away risk in the model. That is, a hedging technique may be used to eliminate stochastic parameters thereby removing risk of stochastic parameter variation from the model. The model may be solved to determine the value of the resource and the parameter values which provide that value of the resource. An iterative scheme may be used to find optimal parameter values which provide an optimal value of the resource.

The property may be indicative of a grade of the resource. The grade may be a proportion of the desired material in a unit of extracted material. That is, the grade may indicate how much of a given unit of material extracted from the resource is in fact the material that provides the resource with its value. As material is extracted from a resource the grade of the resource may vary, such that parts of the extracted resource may include a relatively high proportion of desired material and parts of the extracted resource may include a relatively high proportion of material that has little or no economic value. As such, it has been found to be beneficial to represent a property of a resource such as grade with respect to a parameter based upon a quantity of the resource, thereby allowing modelling of how that parameter varies through a quantity of material that is extracted.

The property of the resource may be a stochastic property. The property of the resource may generally follow a mean reverting process, such as a CIR process, a geometric Brownian process or a mean reverting Brownian process.

The parameter based upon a quantity of the resource may be the rate of extraction.

The rate of extraction may be the rate at which material is extracted from the resource or may indicate, for example, a rate of extraction of desired material from extracted material. Where the rate of extraction indicates a rate at which material is extracted from the resource, the extracted material may be processed to extract desired material or the desired material may be discarded, for example where the grade of the extracted material is low.

The model may comprise a parameter indicative of the economic value associated with the resource and a parameter indicative of the rate of extraction, and wherein each of said parameters is deterministic. The model may be deterministic.

The model may further represent a relationship between the economic value associated with the resource and a parameter indicative of a price of the resource.

The method may further comprise processing the model to generate a value of the rate of extraction which optimises the economic value of the resource.

According to a second aspect of the invention there is provided a method of determining an optimal extraction rate of a resource, the optimal extraction rate being associated with an optimal economic value of the resource. The method comprises receiving a model representing a relationship between an economic value of the resource, an extraction rate and at least one stochastic variable; receiving a control equation, the control equation being based upon the model; and iteratively determining the optimal extraction rate and the optimal economic value by determining values for parameters of the model representing the economic value of the resource and the extraction rate which satisfy the model and the control equation and provide the optimal extraction rate and the optimal economic value of the resource.

Determining an optimal extraction rate of a resource allows the resource to be extracted in a way that optimises the economic value of the resource. However, a model representing a relationship between an economic value of the resource and other factors will in general be a highly complex model. The inventors have realised that the optimal extraction rate can be determined using a control equation based upon the model and an iterative process.

The control equation may be based upon differentiating the model with respect to the extraction rate. The control equation may be further based upon an assumption that a rate of change of the economic value associated with the resource with respect to the extraction rate is equal to zero or is equal to a predetermined minimum.

The optimal economic value associated with the resource may be a maximum value.

Iteratively determining the optimal extraction rate and the optimal economic value may be based upon an n-dimensional grid comprising a plurality of regularly arranged nodes, each dimension of the grid representing a parameter of the model, wherein a distance between nodes in at least one dimension is based upon a maximum value of the extraction rate. The distance between nodes in each dimension may be based upon a maximum value of the extraction rate.

The grid may be an at least three-dimensional grid, a first dimension of the grid representing time, a second dimension of the grid representing a size of the resource and a third dimension of the grid representing price.

Iteratively determining the optimal extraction rate and the optimal economic value may comprise applying the grid to the model and the control equation to generate a discretised model and discretised control equation. The term discretised is intended to indicate that parameters of the model or control equation are evaluated at discrete points.

Iteratively determining the optimal extraction rate and the optimal economic value may comprise: a) receiving a value for the extraction rate; b) generating a value for the economic value associated with the resource by inputting the value of the extraction rate into a first equation, the first equation being based upon the model; and c) generating a value for the extraction rate by inputting the value of the economic value into a second equation, the second equation being based upon the control equation. The method may further comprise carrying out a plurality of iterations of steps b) and c), each iteration using an updated value for the extraction rate and/or the economic value as compared to a previous iteration.

Iteratively determining the optimal extraction rate and the optimal economic value may comprise applying a semi-Lagrangian iterative process.

The at least one stochastic variable may be selected from the group consisting of: a grade associated with the resource; a price associated with the resource; a convenience yield associated with the resource; and an interest rate associated with the resource.

According to a third aspect of the invention there is provided a method of valuing a resource comprising: generating a model representing a relationship between a value associated with the resource and three stochastic variables; and deriving the value associated with the resource based upon the model.

By generating a model representing a relationship between a value associated with the resource and three stochastic variables, a more accurate valuation of the resource may be determined.

The three stochastic variables may be selected from the group consisting of: a grade associated with the resource; a price associated with the resource; a convenience yield associated with the resource; and an interest rate associated with the resource.

The method may further comprise deriving a value associated with an extraction rate of the resource. The value associated with an extraction rate of the resource may be a value providing an optimal value of the economic value of the resource.

According to a fourth aspect of the invention there is provided a method of selecting an extraction rate for a resource comprising: processing a model to generate a first economic value of the resource based upon a first extraction rate; processing data indicating a second economic value associated with a second extraction rate; and selecting one of said first extraction rate and said second extraction rate based upon said first economic value and said second economic value.

By generating economic values of a resource based upon different extraction rates an optimal extraction rate can be selected.

The second extraction rate may be zero. Alternatively the first and second extraction rates may be non-zero extraction rates and data indicating a third economic value associated with a third extraction rate may be processed, said third extraction rate being zero.

The second economic value may be generated by processing a model based upon said second extraction rate.

Selection of one of the first extraction rate and said second extraction rate may be based upon a current extraction rate and a cost associated with changing the extraction rate.

A first cost may be associated with a change of extraction rate from said first extraction rate to said second extraction rate and a second different cost may be associated with a change of extraction rate from said second extraction rate to said first extraction rate.

The model may model one or more parameters selected from the group consisting of: price, resource grade, resource quantity, and time.

According to a fifth aspect of the invention there is provided a method for determining whether to extract a resource based upon a model modelling resource value, the method comprising: determining values of parameters of said model for which extraction of the resource is not economically viable; processing current values for said parameters of said model to determine whether to extract the resource.

In this way, a model modelling resource value can be used to determine values for which extraction is not economically viable and subsequently a straightforward determination can be made as to whether extraction should continue at a current time based upon known parameters of the model at that time.

The determining may be based upon a cost associated with abandonment of the resource.

According to a sixth aspect of the invention there is provided a method for predicting values of parameters indicative of desirability of future extraction of a resource the method comprising: determining values of parameters of said model for which extraction of the resource is not economically viable; modelling likely variation of at least some of said parameters to generate a prediction of at least one of a time for which future extraction is desirable, a probability that the resource extraction will complete, a time at which extraction is expected to be contracted and a time at which extraction is expected to be expanded.

The sixth aspect of the invention therefore provides a method of determining factors that are useful in maximising the value of a resource such as when extraction should be contracted or expanded, as well as factors useful in assessing the viability of extraction of a resource such as a probability that extraction will complete and a time for which extraction is likely to be desirable. Expansion and contraction of extraction of a resource may each have associated costs and these factors may be taken into consideration in the determination of whether extraction should be contracted or expanded.

According to a seventh aspect of the invention there is provided a method for predicting values of variables associated with extraction of a resource, the method comprising: receiving a generic model representing variation in value of a generic variable in terms of variation of a plurality of variables; processing said model to generate a plurality of specific models, each associated with a specific variable, each specific model modelling variation in value of a specific one of said variables associated with extraction of said resource in terms of variation of the plurality of variables; determining values for a first one of said specific variables based upon a respective one of said specific models; and using said determined values to determine values for others of said specific variables based upon respective ones of said specific models.

Using a generic model to generate a plurality of specific models allows different variables to be modelled in a corresponding way. Each of the models may have associated boundary conditions which are either difficult to determine directly or cannot be determined directly. However a first one of the specific models may be used to determine values which can be used to determine the boundary conditions associated with the other models such that solving the other models is possible. In this way, values of variables associated with extraction of a resource that cannot normally be determined can be found.

The generic model may be a model determined based upon a general class of expectations associated with extraction of the resource.

Processing said model to generate a plurality of specific models, each associated with a specific variable, may comprise applying conditions to said generic model.

The first one of said specific variables may be a variable indicating a valuation of the resource.

Using said determined values to determine values for others of said specific variables may comprise determining a boundary condition for said respective ones of said specific models modelling said others of said specific variables.

The boundary condition may be defined by values for one or more of said plurality of variables at which extraction of said resource is abandoned.

The others of said specific variables may be at least one of a time for which future extraction is desirable and a probability that the resource extraction will complete.

In each of the aspects of the invention the resource may be a natural resource such as a mine. The natural resource may be, for example, oil, gas, coal, gold or any other mineral which it is desirable to accurately value. The rate of extraction may be a rate of removal from a natural reserve. The rate of extraction may be controllable.

Features described in the context of one aspect of the invention may be applied in the context of other aspects of the invention.

It will be appreciated that aspects of the invention can be implemented in any convenient form. For example, the invention may be implemented by appropriate computer programs which may be carried on appropriate carrier media which may be tangible carrier media (e.g. computer readable media such as disks) or intangible carrier media (e.g. communications signals). Aspects of the invention may also be implemented using suitable apparatus which may take the form of programmable computers running computer programs arranged to implement the invention.

Embodiments of the present invention will now be described, by way of example only, with reference to the accompanying drawings, in which:

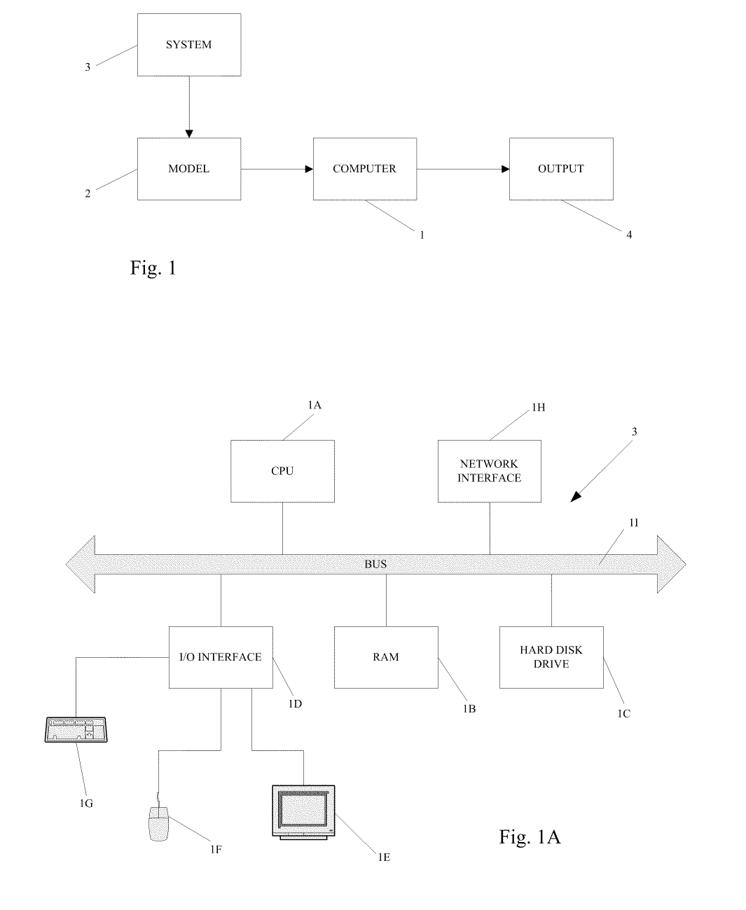

FIG. 1 is a schematic illustration of a system for processing a model of a real world system;

FIG. 1A is a schematic illustration of a computer of FIG. 1 in further detail;

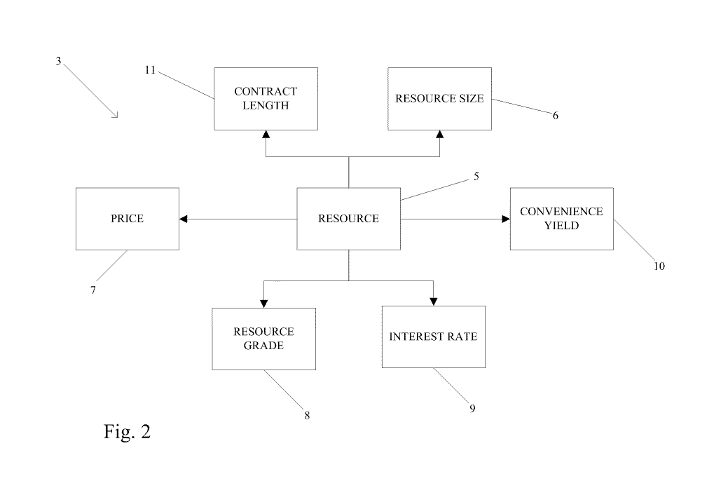

FIG. 2 is a schematic illustration of a real world system suitable for processing using the system of FIG. 1;

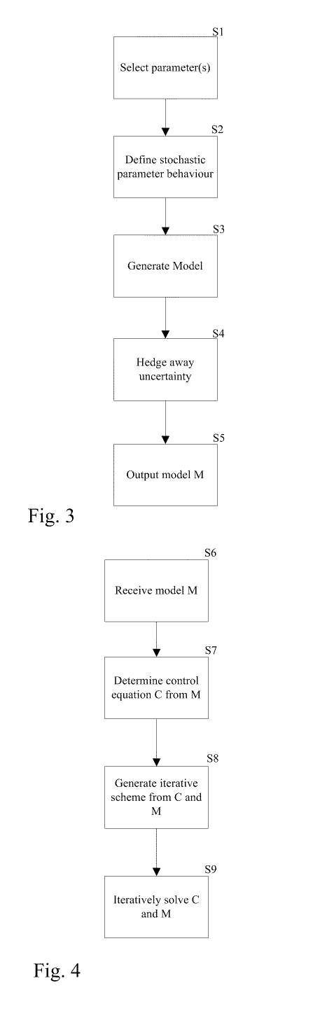

FIG. 3 is a flowchart showing processing to generate a model suitable for processing using the system of FIG. 1;

FIG. 4 is a flowchart showing processing to determine an optimal value for a parameter of a model; and

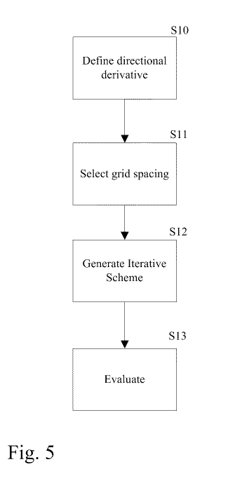

FIG. 5 is a flowchart showing part of the processing of FIG. 4 in further detail.

Referring now to FIG. 1, a computer 1 is arranged to receive a mathematical model 2 of a real world system 3 and to generate output 4. The real world system 3 includes uncertainty and the output 4 is an endogenous parameter of the system (i.e. a parameter that is internal to the system) that may be controlled. For example the real world system 3 may be a mining system and output 4 may be an extraction rate of a resource that may be controlled and which may be optimised to maximise the value of the resource. In such a mining system it is desirable to extract a resource at an extraction rate which maximises the value of the resource, and the value of the resource may depend upon stochastic uncertainties such as price, convenience yield, interest rate and resource grade.

FIG. 1A shows the structure of the computer 1 in further detail. It can be seen that the computer 1 comprises a CPU 1A, and random access memory (RAM) 1B which in use provides volatile storage for both programs and data. The computer 1 further comprises non-volatile storage in the form of a hard disk drive 1C. An input/output (I/O) interface 1D connects input and output devices to the computer 1. It can be seen that an output device in the form of a display screen 1E is connected to the I/O interface 1D. It can also be seen that input devices comprising a mouse 1F and a keyboard 1G are connected to the I/O interface 1D. The computer 1 further comprises a network interface 1H providing means to connect the computer 1 to a local area network. The CPU 1A, the RAM 1B, the hard disk drive 1C, the I/O interface 1D and the network interface 1H are all connected together by means of a communications bus 1I. Data representing the model 2 of FIG. 1 is stored in the hard disk drive 1C and computer readable instructions are stored in the RAM 1B. The CPU 1A processes the data representing the model 2 of FIG. 1 using the computer readable instructions stored in the RAM 1B to determine the output 4 of FIG. 1.

An example of the real world system 3 of FIG. 1 is shown in FIG. 2. The system 3 has a resource 5 having an associated value. The value of the resource 5 at a particular time is dependent upon factors including a size of the resource 6, a price 7 which indicates the price achievable for a unit of the resource, a resource grade 8 which indicates the quality of the resource, a rate of risk free interest 9 which indicates the interest rate that can be obtained with no default risk and a convenience yield 10 which indicates, amongst other things, storage and transportation costs associated with holding a quantity of the resource 5. That is, when determining the value of the resource, the convenience yield takes into account costs associated with transportation and storage. The value of the resource to a company may also depend upon a length of time a company has to extract the resource such as a length of contract 11. Each of price 7, interest rate 9 and convenience yield 10 are exogenous factors (i.e. factors deriving from outside of the system), and each of price 7, resource grade 8, interest rate 9 and convenience yield 10 are stochastic factors whose behaviour is non-deterministic. It is desirable to optimise the resource value 5 based upon endogenous factors such as a rate of extraction of the resource while taking into account stochastic and endogenous factors.

The real world system 3 can be mathematically modelled to generate model 2 of FIG. 1, and model 2 may be processed to determine output 4 indicating an optimal value of an endogenous parameter of the real world system 3. In some embodiments, in order to simplify model 2, only a part of the real world system 3 may be modelled. For example, if it is known that some factors of the real world system 3 have relatively little effect on the determination of output 4, these factors may be omitted from model 2. Modelling only a part of the real world system 3 may provide a model allowing sufficiently accurate determination of output 4 of FIG. 1. It will be appreciated that selection of parts of a real world system to be modelled is inevitably a trade off between reduction of computational complexity of determination of a solution of the model and sufficient accuracy.

Referring now to FIG. 3, generation of model 2 of FIG. 1 is shown at a high level. The processing of FIG. 3 will be described with reference to a model of a valuation V associated with a resource such as the resource 5 of FIG. 2 in which V is a function of a single stochastic factor, price 7 indicated by a variable S, together with resource size 6 indicated by a non-stochastic variable Q and time indicated by a variable t. The valuation V can therefore be defined as a stochastic function V(S, Q, t).

At step S1 the exogenous factors that affect the model are determined. At step S2 behaviour of each of the stochastic variables in the model over time is determined. The behaviour of S may be modelled in a variety of ways, for example as a geometric Brownian process, as a mean reverting process or as a CIR process. An example CIR process is given below at equation (25). In the case where the behaviour of S is modelled as a geometric Brownian motion its behaviour is modelled by Equation (1) below:

dS=μSdt+σₛSdXₛ (1)

where:
μ is a constant indicating the drift, or average growth rate per unit time, of S;
σₛ is a constant indicating the volatility of S; and
dXₛ is a differential of Brownian motion and is normally (or Gaussian) distributed as N(0,√dt).

The drift and volatility of S, μ and σₛ are known constants determined based on historical data.

At step S3 a model of the behaviour of V(S, Q, t) is generated using Itō's Lemma. Itō's Lemma states for a two variable function f(X,t) where dX=ydt+zdB and where dB is a differential of Brownian motion, then df(X,t) is given by equation (2) below:

$$d f = z \frac{\partial f}{\partial X} d B + ( \frac{1}{2} {z}^{2} \frac{{\partial }^{2} f}{\partial {X}^{2}} + \frac{\partial f}{\partial t} + y \frac{\partial f}{\partial X} ) d t \qquad ( 2 )$$

where:
the notation

$$\frac{\partial f}{\partial ϕ}$$

indicates a first-order partial derivative of f with respect to a variable φ; and
the notation

$$\frac{{\partial }^{2} f}{\partial {ϕ}^{2}}$$

indicates a second-order partial derivative of f with respect to a variable φ.
Applying Itō's Lemma to V(S, Q, t) based upon the parameter behaviour defined at step S2 according to equation (1) gives equation (3) below.

$$d V = {σ}_{s} S \frac{\partial V}{\partial S} d {X}_{s} + ( \frac{1}{2} {σ}_{s}^{2} {S}^{2} \frac{{\partial }^{2} V}{\partial {S}^{2}} + \frac{\partial V}{\partial t} + μ S \frac{\partial V}{\partial S} ) d t + \frac{\partial V}{\partial Q} d Q \qquad ( 3 )$$

Note that the term

$$\frac{\partial V}{\partial Q} d Q$$

appears in equation (3) given that V is a function of t and Q. The change in the resource size Q is dependent upon the rate of extraction q as defined by dQ=−qdt. Substituting −qdt for dQ in equation (3) gives equation (4):

$$d V = {σ}_{s} S \frac{\partial V}{\partial S} d {X}_{s} + ( \frac{1}{2} {σ}_{s}^{2} {S}^{2} \frac{{\partial }^{2} V}{\partial {S}^{2}} + \frac{\partial V}{\partial t} + μ S \frac{\partial V}{\partial S} ) d t - q \frac{\partial V}{\partial Q} d t \qquad ( 4 )$$

and rearranging equation (4) gives equation (5) below.

$$d V = {σ}_{s} S \frac{\partial V}{\partial S} d {X}_{s} + ( \frac{1}{2} {σ}_{s}^{2} {S}^{2} \frac{{\partial }^{2} V}{\partial {S}^{2}} + \frac{\partial V}{\partial t} - q \frac{\partial V}{\partial Q} + μ S \frac{\partial V}{\partial S} ) d t \qquad ( 5 )$$

The term dX, in equation (5) is a random variable and introduces uncertainty to the model of V. As such, at step S4 of FIG. 3 the uncertainty in the model is hedged away. Uncertainty in the model of Equation (5) may be hedged away by creating a financial portfolio Π which has value V and which is short a₁ units at a price S. That is, the portfolio has sold a₁ units at price S which have been borrowed from a third party with the intention of buying identical assets back at a later date to return to the lender. The portfolio Π therefore can be seen to comprise two parts, Π₁ and Π₂ and is given by equation (6) below:

Π=Π₁+Π₂ (6)

where Π₁=V and Π₂=−a₁S.

A small change in the value of the portfolio, dΠ, is equal to the change in the valuation V, dV, combined with a₁ amounts of the change in the price S, dS, and is given by equation (7):

dΠ=dV−a₁dS (7)

Substituting Equations (1) and (5) into equation (7) gives equation (8):

$$d Π = ( {σ}_{s} S \frac{\partial V}{\partial S} d {X}_{s} + ( \frac{1}{2} {σ}_{s}^{2} {S}^{2} \frac{{\partial }^{2} V}{\partial {S}^{2}} + \frac{\partial V}{\partial t} - q \frac{\partial V}{\partial Q} + μ S \frac{\partial V}{\partial S} ) d t ) - {a}_{1} ( μ S d t + {σ}_{s} S d {X}_{s} ) \qquad ( 8 )$$

Selecting a₁ to be equal to

$$\frac{\partial V}{\partial S}$$

and expanding the term a₁(μSdt+σₛSdXₛ) in equation (8) gives a term

$$- μ S \frac{\partial V}{\partial S} d t$$

and a term

$$- {σ}_{s} S \frac{\partial V}{\partial S} d {X}_{s}$$

which can both be cancelled with corresponding terms to give Equation (9). The selection of a₁ to be equal to

$$\frac{\partial V}{\partial S}$$

introduces the same uncertainty in the price of the sold stock as the uncertainty in the owned resource resulting from price uncertainty. As such, if the amount a₁ is continually adjusted so that the portfolio is always short

$$\frac{\partial V}{\partial S}$$

units the uncertainties within the portfolio are equal and opposite at all times and the portfolio is risk free. That is to say, the price uncertainty of the resource valuation will be equal and opposite to the price uncertainty arising from the short position and the total value of the portfolio is unaffected by the uncertainty.

$$d Π = ( \frac{1}{2} {σ}_{s}^{2} {S}^{2} \frac{{\partial }^{2} V}{\partial {S}^{2}} + \frac{\partial V}{\partial t} - q \frac{\partial V}{\partial Q} ) d t \qquad ( 9 )$$

As can be seen from Equation (9), the portfolio no longer contains the random term dXₛ and the portfolio can therefore be considered to be risk free.

The total value of the portfolio is given by the combined increase of each of the respective parts of the portfolio, minus the reduction in economic value of the portfolio associated with any quantity of extracted resource. The increase in the value of the portfolio is modelled by Equation (10):

dΠ=ΣrᵢΠᵢdt−(qS−ε)dt (10)

where:
Πᵢ is the ith part of the portfolio;
rᵢ indicates the rate of increase of the part of the portfolio Πᵢ given that the portfolio is risk-free;
q is the extraction rate of the resource and is a function q(Q, S, t);
ε is the extraction cost and is a function of the extraction rate, resource size and time, ε(q, Q, t); and
(qS−ε) is the economic value associated with any extracted resource.

Substituting Equation (6) into Equation (10) with

$${a}_{1} = \frac{\partial V}{\partial S}$$

gives Equation (11) below.

$$d Π = ( {r}_{1} V - {r}_{2} \frac{\partial V}{\partial S} S ) d t - ( qS - ɛ ) d t \qquad ( 11 )$$

The rate of increase of the value of the resource V in a risk free portfolio, indicated as r₁ in equation (11), is given by the risk free interest rate r. The rate of increase of the part of the risk free portfolio

$$\frac{\partial V}{\partial S} S ,$$

indicated by r₂ in equation (11) is given by the risk free interest rate minus the convenience yield associated with the part of the extracted resource (r−ε), given that the convenience yield indicates costs associated with holding the resource.

Substituting values for r₁ and r₂ into equation (11) gives equation (12).

$$d Π = ( rV - ( r - δ ) \frac{\partial V}{\partial S} S ) d t - ( qS - ɛ ) d t \qquad ( 12 )$$

Given that the right hand sides of Equations (9) and (12) are both equal to dΠ, the right hand sides of Equations (9) and (11) can be set to be equal to one another to give Equation (13):

$$( rV - ( r - δ ) \frac{\partial V}{\partial S} S ) d t - ( qS - ɛ ) d t = ( \frac{1}{2} {σ}_{s}^{2} {S}^{2} \frac{{\partial }^{2} V}{\partial {S}^{2}} + \frac{\partial V}{\partial t} - q \frac{\partial V}{\partial Q} ) d t \qquad ( 13 )$$

Rearranging Equation (13) gives equation (14):

$$\frac{\partial V}{\partial t} - q \frac{\partial V}{\partial Q} + ( r - δ ) S \frac{\partial V}{\partial S} + \frac{1}{2} {σ}_{s}^{2} {S}^{2} \frac{{\partial }^{2} V}{\partial {S}^{2}} - rV + qS - ɛ = 0 \qquad ( 14 )$$

Equation (14) is a model M of the stochastic function V(S, Q, t), in which only the variable S (indicating price) is a stochastic variable. The other variables r (indicating risk free interest rate), Q (indicating size of resource), δ (indicating convenience yield), q (indicating extraction rate), ε (indicating a cost, which may comprise costs associated with extraction εₘ and costs associated with processing εₚ) and t (indicating time) are each modelled as deterministic variables. In some embodiments where cost ε is modelled as costs associated with extraction εₘ and costs associated with processing εₚ, the term qS−ε is modelled such that costs associated with processing are only incurred when processing is economically viable, that is where qS−εₚ is greater than 0. In such embodiments the term max(0, qS−εₚ)−εₘ is substituted for the term qS−ε in Equation (14). As will be discussed in further detail below, the model M of Equation (14) can be solved to determine an optimal extraction rate q* which provides an optimal valuation V* of the resource.

The model of equation (14) has boundary conditions (14.1), (14.2) and (14.3) below.

V=0 on Q=0 (14.1)

Where (14.1) indicates that when the reserve is exhausted the value of the reserve is zero.

Given that extraction rate has a physical upper bound, extraction rate (q) and cost (ε) behave as if independent of S when S is large. As such, when S is large, the valuation can be viewed as a function of S only. This permits a linear approximation for the valuation when S is large of the form given in equation (14.2);

V→mS+c as S→∞ (14.2)

where m is a function of the form A(Q, t) and c is a function of the form B(Q, t). A linear approximation is permitted because at any fixed point in time the values of Q and t are known and constant. Consequently at a fixed point in time the functions A and B also take values that are known and constant. If S tends to infinity for these constant values of Q and t, the non-linear effects of S on V become unimportant due to the physical upper bound on the extraction rate. The non-linear effects are replaced by a component c which is independent of S and a component m which is a fixed multiple of S. The forms of equations A(Q, t) and B(Q, t) which hold as S tends to infinity are deducible from equation (14). Boundary condition (14.2) is itself bounded by (14.1) and (14.3):

V=0 at t=T (14.3)

Where (14.3) indicates that at an end time T, indicating that no further time remains for extracting the resource such as at the expiry of a contract, the value of the resource is zero.

Whilst the processing of FIG. 3 to generate a model of a system has been described above using an example stochastic function V(S, Q, t) with a single stochastic variable S indicating a price of a resource, it will be appreciated that the processing of FIG. 3 is equally applicable to stochastic functions dependent upon any suitable stochastic variable with any suitable behaviour, such as geometric Brownian motion with or without mean reversion. It will further be appreciated that any suitable method of hedging away uncertainty from the model can be used in place of the method described above.

It is desirable to determine the optimal valuation V* of a resource and the corresponding optimal extraction rate q*. The optimal extraction rate will vary based upon the price S, the size of the resource Q and end time T, that is q*(S, Q, T). Determination of q*(S, Q, T) will now be described with reference to FIGS. 4 and 5.

At step S6 the model to be processed M, given by equation (14), is received and at step S7 a control equation C is determined from M. The control equation indicates a relationship between V* and q* and may be obtained by differentiating equation (14) with respect to q and setting

$$\frac{\partial V}{\partial q} = 0$$

for all q. Differentiating equation (14) with respect to q gives equation (15).

$$\frac{\partial }{\partial q} ( \frac{\partial V}{\partial t} ) - \frac{\partial V}{\partial Q} + \frac{\partial }{\partial q} ( ( r - δ ) S \frac{\partial V}{\partial S} ) + \frac{\partial }{\partial q} ( \frac{1}{2} {σ}_{s}^{2} {S}^{2} \frac{{\partial }^{2} V}{\partial {S}^{2}} ) - \frac{\partial }{\partial q} ( rV ) + S - \frac{\partial }{\partial q} ɛ = 0 \qquad ( 15 )$$

Equation (15) can be rearranged to give equation (16):

$$\frac{\partial }{\partial t} ( \frac{\partial V}{\partial q} ) - \frac{\partial V}{\partial Q} + \frac{\partial V}{\partial q} ( ( r - δ ) S \frac{\partial }{\partial S} ) + \frac{\partial V}{\partial q} ( \frac{1}{2} {σ}_{s}^{2} {S}^{2} \frac{{\partial }^{2}}{\partial {S}^{2}} ) - r ( \frac{\partial V}{\partial q} ) + S - \frac{\partial }{\partial q} ɛ = 0 \qquad ( 16 )$$

Setting

$$\frac{\partial V}{\partial q} = 0$$

for all q implies that q is always a value maximising rate, i.e. the rate of change of V with respect to q is zero, and gives a control equation C, given by equation (17) below.

$$- \frac{\partial V}{\partial Q} + S - \frac{\partial ɛ}{\partial q} = 0 \qquad ( 17 )$$

At step S8 an iterative scheme is generated from C and M. The values of V* and q* are determined iteratively due to the interdependence of each of the values V* and q*. The generation of an iterative scheme is described in further detail below with reference to FIG. 5. At step S9 the iterative scheme generated at step S8 is iteratively solved to determine the values V* and q*.

Referring now to FIG. 5, the generation of an iterative scheme of step S8 of FIG. 4 is shown in further detail. The iterative scheme of FIG. 5 is based upon a semi-Lagrangian iterative scheme.

At step S10 a directional derivative DV/Dτ, indicating the rate of change of V in a direction τ, is defined according to Equation (18):

$$\frac{DV}{D τ} = \frac{\partial V}{\partial τ} + \frac{d Q}{d τ} \frac{\partial V}{\partial Q} \qquad ( 18 )$$

where:

τ=T−t and indicates the time left to the end of the period of time available for utilising the resource (for example the expiry of the contract for extracting the resource). Given the relationship between τ and t it can be seen that

$$\frac{\partial V}{\partial t} = - \frac{\partial V}{\partial τ}$$

because τ and t indicate change of time in opposite directions.

Assuming

$$\frac{\partial Q}{\partial τ} = q ,$$

indicating that the rate of change of the size of the resource is given by the extraction rate, and substituting

$$- \frac{\partial V}{\partial τ} for \frac{\partial V}{\partial t} ,$$

the model M of Equation (14) can be rewritten according to Equation (19) below:

$$\frac{\partial V}{\partial τ} + \frac{\partial Q}{\partial τ} \frac{\partial V}{\partial Q} = ( r - δ ) S \frac{\partial V}{\partial S} + \frac{1}{2} {σ}_{s}^{2} {S}^{2} \frac{{\partial }^{2} V}{\partial {S}^{2}} - rV + qS - ɛ \qquad ( 19 )$$

Substituting Equation (18) into Equation (19) gives Equation (20):

$$\frac{DV}{D τ} = ( r - δ ) S \frac{\partial V}{\partial S} + \frac{1}{2} {σ}_{s}^{2} {S}^{2} \frac{{\partial }^{2} V}{\partial {S}^{2}} - rV + qS - ɛ \qquad ( 20 )$$

For algebraic convenience, L {V} is defined to be Equation (21):

$$L \{ V \} ≡ \frac{1}{2} {σ}_{s}^{2} {S}^{2} \frac{{\partial }^{2} V}{\partial {S}^{2}} + ( r - δ ) S \frac{\partial V}{\partial S} - rV \qquad ( 21 )$$

and Equation (21) is substituted into Equation (20) to give Equation (22) below:

$$\frac{DV}{D τ} = L \{ V \} + qS - ɛ \qquad ( 22 )$$

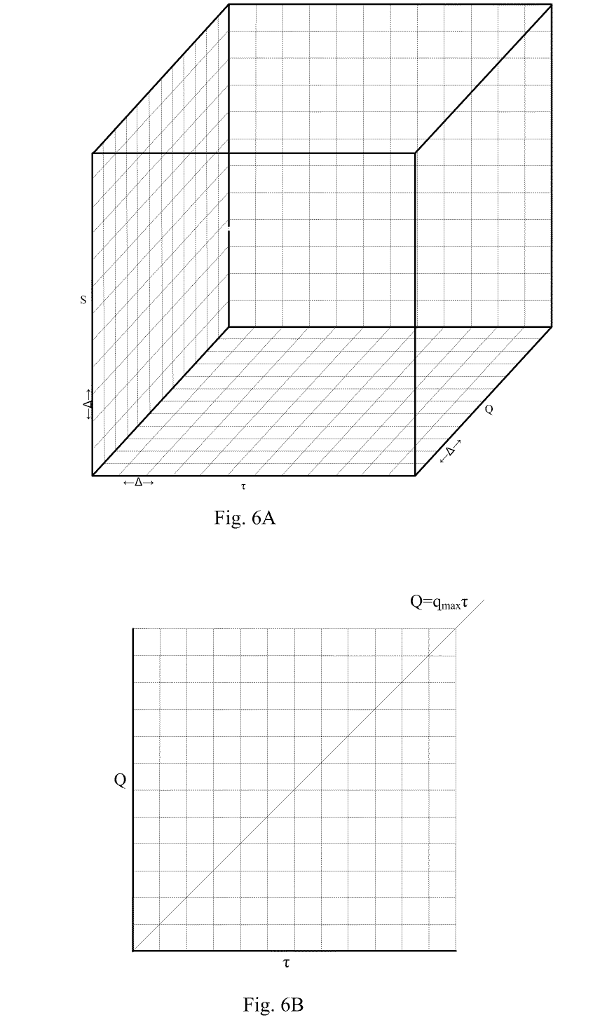

At step S11 a grid spacing Δ is determined. The grid spacing Δ is a distance between nodes in each dimension of a regular lattice in S, Q and τ as illustrated in FIG. 6A. Discretising the system in this way allows the system to be evaluated at discrete points on each of the S, Q and τ axes.

The grid spacing Δ is selected such that ΔQ=qₘₐₓΔt where qₘₐₓ is the maximum rate of extraction. Selecting the grid spacing in this way results in nodes in the Q and τ dimensions of the discretised system falling on a line Q=qₘₐₓτ, as shown in FIG. 6B. The line Q=qₘₐₓτ is a characteristic line of the system and separates a region of the system in which all of the resource can be extracted before the end time T and a region of the system in which all of the resource cannot be extracted before the end of time T. This can be seen to be the case by considering the path through the domain Q×τ which satisfies the equation dQ/dτ=qₘₐₓ, indicating that the size of Q changes with respect to τ at the maximum rate of extraction. Using the initial condition that Q(τ=0)=0, indicating that at time T the size of the resource is zero (i.e. no more resource is available), gives the characteristic line Q=qₘₐₓτ.

At step S12 an iterative scheme is generated. An iterative scheme corresponding to equations (22) and (14) is given by Equations (23) and (24) below where equation (22) is written as:

$$\frac{{V}_{i , j}^{k} - V ( {S}_{i} , {Θ}_{i , j}^{k - 1} , {τ}_{k - 1} )}{Δτ} = L \{ {V}_{i , j}^{k} \} + {\hat{q}}_{i , j}^{k} S - ɛ ( {\hat{q}}_{i , j}^{k} , {Q}_{j} , {τ}_{k} ) \qquad ( 23 )$$

where:
V_{i,j}^{k}=v(Sᵢ,Qⱼ;τₖ);
\hat{q}_{i,j}^{k}=\hat{q}(Sᵢ,Qₚ,τₖ);
\hat{q} indicates an updated value of q;

Θ_{i,j}^{k} is an equation of a characteristic line that satisfies the condition that the line arrives at a point Qⱼ at time τₖ, assuming that q is constant across τε(τₖ₋₁,τₖ) and is given by Θ_{i,j}^{k}=Qⱼ+q_{i,j}^{k}(τ−τₖ); and
ε is a single valued function.

If the point (Sᵢ,Θ_{i,j}^{k-1},τₖ₋₁) does not coincide with a node of the system, linear interpolation is used to determine the value V(Sᵢ,Θ_{i,j}^{k-1},τₖ₋₁).

Equation (14) is written as:

$$f ( {q}_{i , j}^{k} ) = \frac{{\hat{V}}_{i , j}^{k} - {\hat{V}}_{i , j - 1}^{k}}{Δ Q} + S \qquad ( 24 )$$

where:
f is an invertible function given by f=dε/dq;
q_{i,j}^{k}=q(Sᵢ,Qᵢ,τₖ);
\hat{V}_{i,j}^{k}=\hat{V}(Sᵢ,Qⱼ,τₖ); and
\hat{V} indicates an updated value of V.

In each of Equations (23) and (24) the values q and \hat{q} are in the range qₘᵢₙ and qₘₐₓ. The scheme given by equations (23) and (24) is first-order accurate in τ and Q and second-order accurate in S and can be shown to be both consistent and convergent.

At step S13 the discretised system is evaluated using an iteration scheme in which Equations (23) and (24) are solved. Where the valuation V is a valuation of a resource it is typically the case that qₘᵢₙ=0, where qₘᵢₙ=q_{i,0}^{k}, and this gives a boundary condition V_{i,0}^{k}=0 indicating that for any value of S, if the size of the reserve is zero, then the value of the reserve is zero. Given the boundary condition V_{i,0}^{k}=0 it is possible to solve for increasing values of q starting from qₘᵢₙ. That is, in a first iteration, a value of q_{i,1}^{k}, where q_{i,1}^{k} is a first value after qₘᵢₙ is used as a basis for evaluation of equation (24) to give a value for \hat{V}. The value of \hat{V} is then used as a basis for evaluation of equation (23) to provide an updated value \hat{q}. The updated value \hat{q} is then used as a basis for a further evaluation of equation (24) and so the iterative scheme continues until a stopping condition is satisfied. Equations (23) and (24) may then be solved for V across all values of i, for constant j, with a direct solver.

For simple forms of ε the scheme converges in approximately 4 iterations. The iterative solution is accurate to approximately 0.01% across the Q and S space for a typical value of τ within a time of approximately 10 seconds using an Intel Pentium 3.20 GHz processor.

The above method provides an accurate method for determining q* and V*. It is possible to determine a simple approximation for q* where the size of the reserve Q is large directly from the control equation (17). First note that where Q is large, the change in the value of the resource V with respect to Q,

$$\frac{\partial V}{\partial Q} ,$$

is small as removal of one unit from the reserve will have a very small impact on the valuation V. As such

$$\frac{\partial V}{\partial Q}$$

can be approximated as having a value zero for large values of Q. Substituting the approximation of

$$\frac{\partial V}{\partial Q} = 0$$

into equation (17) gives an approximation

$$S = \frac{\partial ɛ}{\partial q} .$$

Provided the derivative of 8 with respect to q exists, it is possible to solve for an approximation to q* as the root of

$$S = \frac{\partial ɛ}{\partial q} .$$

It has been described above that a model can be solved using a semi-Lagrangian iterative scheme. In an alternative embodiment an implicit finite-difference scheme on a fixed grid could be used, although a semi-Lagrangian iterative scheme is advantageous as discontinuities in the payoff or boundary conditions may be retained in a solution using a semi-Lagrangian scheme. Additionally, using a semi-Lagrangian scheme it is possible in some cases to solve a one factor optimisation problem without iterating which is beneficial in reducing computation time.

The processing of FIG. 3 described above has been illustrated by way of a valuation that is a function of a single stochastic factor. The processing of FIG. 3 can additionally be used to model stochastic functions with more than one stochastic variable. For example, it may be desirable to model V as a stochastic function which includes price and grade uncertainty (where grade indicates a proportion of the resource in a unit of extracted material). At step S1 of FIG. 1 the parameters are selected such that V is a function of S, G, Q and t, that is V(S, G, Q, t), where Q and t are non-stochastic variables as above. At step S2 the behaviour of the price variable S is as defined in Equation (1) and G is the grade of the extracted material, indicating a fraction of the extracted material that is in fact the resource being extracted, and follows a CIR mean-reverting process defined in equation (25):

dG=k(α−G)d Q̅+σ_{G}\sqrt{G}dX_{G} (25)

where:
α is the mean value of G;
k is the rate at which the value G reverts to its mean;
Q̅ is the quantity of material already extracted such that Q=Qₘₐₓ− Q̅;
σ_{G} is the volatility of G; and
dX_{G} is a differential of Brownian motion and is normally distributed as N(0,√dt).

The use of in equation (25) sets grade quality to always be positive. The use of Q̅ in equation (25) sets the quantity of material extracted to be positive, i.e. prevents material being returned to the ground. Material only being extracted from the ground is the usual case for mines and some other natural resources.

Setting there to be no correlation between S and G and applying Itō's Lemma to V(S, Q, G, t) based upon the parameter behaviour defined at step S2 according to equation (1) for S and equation (25) for G gives equation (26) below.

$$d V = {σ}_{s} S \frac{\partial V}{\partial S} d {X}_{s} + {σ}_{G} \sqrt{G} \frac{\partial V}{\partial G} d {X}_{G} + ( \frac{1}{2} {σ}_{s}^{2} {S}^{2} \frac{{\partial }^{2} V}{\partial {S}^{2}} + \frac{\partial V}{\partial t} + μ S \frac{\partial V}{\partial S} ) d t + ( \frac{\partial V}{\partial \overline{Q} } + \frac{1}{2} {σ}_{G}^{2} G \frac{{\partial }^{2} V}{\partial {G}^{2}} + k ( α - G ) \frac{\partial V}{\partial G} ) d \overline{Q} \qquad ( 26 )$$

Powers of (dt)² and (d Q̅)² resulting from the application of Itō's Lemma are assumed to be negligible and are therefore omitted from equation (26).

Given the relationship between Q and Q̅, Q̅ can be replaced with Q in equation (26) by changing the sign of the terms including Q̅, to give equation (27).

$$d V = {σ}_{s} S \frac{\partial V}{\partial S} d {X}_{s} + {σ}_{G} \sqrt{G} \frac{\partial V}{\partial G} d {X}_{G} + ( \frac{1}{2} {σ}_{s}^{2} {S}^{2} \frac{{\partial }^{2} V}{\partial {S}^{2}} + μ S \frac{\partial V}{\partial S} ) d t - ( - \frac{\partial V}{\partial Q} + \frac{1}{2} {σ}_{G}^{2} G \frac{{\partial }^{2} V}{\partial {G}^{2}} + k ( α - G ) \frac{\partial V}{\partial G} ) d Q \qquad ( 27 )$$

The rate of extraction q is a function q(S, G, Q, t), and, as for the one factor model, satisfies the relationship dQ=−qdt and is subject to physical and practical constraints on its maximum and minimum values such that q is in the range [qₘᵢₙ, qₘₐₓ]. Substituting −qdt for dQ into equation (27) gives equation (28).

$$d V = {σ}_{s} S \frac{\partial V}{\partial S} d {X}_{s} + {σ}_{G} \sqrt{G} \frac{\partial V}{\partial G} d {X}_{G} + ( \frac{1}{2} {σ}_{s}^{2} {S}^{2} \frac{{\partial }^{2} V}{\partial {S}^{2}} + \frac{\partial V}{\partial t} + μ S \frac{\partial V}{\partial S} ) d t + ( - \frac{\partial V}{\partial Q} + \frac{1}{2} {σ}_{G}^{2} G \frac{{\partial }^{2} V}{\partial {G}^{2}} + k ( α - G ) \frac{\partial V}{\partial G} ) ( q d t ) \qquad ( 28 )$$

Equation (28) can be rearranged to give equation (29) below:

$$d V = {σ}_{s} S \frac{\partial V}{\partial S} d {X}_{s} + {σ}_{G} \sqrt{G} \frac{\partial V}{\partial G} d {X}_{G} + ( \begin{matrix}\frac{\partial V}{\partial t} - q \frac{\partial V}{\partial Q} + \frac{1}{2} {σ}_{s}^{2} {S}^{2} \frac{{\partial }^{2} V}{\partial {S}^{2}} + μ S \frac{\partial V}{\partial S} + \\ q \frac{1}{2} {σ}_{G}^{2} G \frac{{\partial }^{2} V}{\partial {G}^{2}} + qk ( α - G ) \frac{\partial V}{\partial G}\end{matrix} ) d t \qquad ( 29 )$$

which is of the general form (29a):

dV=a₂dt+b₂dXₛ+c₂dX_{G} (29a)

The uncertainty in the model provided by the random terms dXₛ and dX_{G} are hedged away at step S4 of FIG. 3. The random terms dXₛ and dX_{G} in equations (29) and (29a) can be hedged away in any convenient way. For example the random terms can be hedged away in a similar manner to that described above for the model in which only one variable is stochastic, with reference to equations (8), (9) and (10) as described below.

A financial portfolio Π which has value V and which is short γₛ units of resource at a price S and is short γ_{G} amounts of call options F to buy a share in the same resource having value V is created according to equation (30).

Π=Π₁+Π₂+Π₃ (30)

where:
Π₁=V;
Π₂=−γₛS; and
Π₃=−γ_{F}F.

Since the call option is an option to buy a share in the resource having value V the call option has the same uncertainty in grade quality as the resource having value V. An increment in the value of F is a function of S and G and therefore also contains some price uncertainty. The variables γₛ and γ_{G} may be adjusted independently of each other and as such the two variables may be adjusted to ensure that the combined effect of γₛ and γ_{G} hedges the independent risks associated with S and G. The increment in the value of F has the same form as equation (29) and is given by equation (31) below:

$$d F = {σ}_{s} S \frac{\partial F}{\partial S} d {X}_{s} + {σ}_{G} \sqrt{G} \frac{\partial F}{\partial G} d {X}_{G} + ( \begin{matrix}\frac{\partial F}{\partial t} - q \frac{\partial F}{\partial Q} + \frac{1}{2} {σ}_{s}^{2} {S}^{2} \frac{{\partial }^{2} F}{\partial {S}^{2}} + μ S \frac{\partial F}{\partial S} + \\ q \frac{1}{2} {σ}_{G }^{2} G \frac{{\partial }^{2} F}{\partial {G}^{2}} + qk ( α - G ) \frac{\partial F}{\partial G}\end{matrix} ) d t \qquad ( 31 )$$

which has the general form shown in equation (31a).

dF=a₃dt+b₃dXₛ+c₃dX_{G} (31a)

A small change in the portfolio Π is given by equation (32) below:

dΠ=dV−γₛdS−γ_{F}dF (32)

Substituting equations (29a), (1) and (31a) into equation (32) gives equation (33):

dΠ=a₂dt+b₂dXₛ+c₂dX_{G}−γₛ(μSdt+σₛSdXₛ)−γ_{F}(a₃dt+b₃dX_{S}+c₃dX_{G}) (33)

Equation (33) can be rearranged to give equation (34) below:

dΠ=(a₂−γₛμS−γ_{F}a₃)dt+(b₂−γₛσₛS−γ_{F}b₃)dX_{S}+(c₂−γ_{F}c₃)dX_{G} (34)

Now setting γ_{F}=c₂/c₃ and γₛ=(b₂−γ_{F}b₃)/σₛS results in the terms (b₂−γₛσₛS−γ_{F}b₃) and (c₂−γ_{F}c₃) being equal to zero and gives equation (35):

dπ=(a₂−γₛμS−γ_{F}a₃)dt (35)

Equation (35) no longer contains uncertainty and the portfolio Π can therefore be considered to be risk free. The total value of the portfolio is given by the combined risk free increase of each of the respective parts of the portfolio, minus the reduction in the value of the portfolio associated with any extracted resource and is given by equation (36):

dΠ=ΣrᵢΠᵢdt−(qSG−ε)dt (36)

where:
Πᵢ is the ith part of the portfolio;
rᵢ indicates the rate of increase of the part of the portfolio Πᵢ given that the portfolio is risk-free; and
(qSG−ε) is the economic value associated with any extracted resource.

It can be seen that Equation (36) corresponds to Equation (10) for the model in which only one variable is stochastic, but with qS in Equation (10) substituted for qSG in Equation (36). The factor G appears in the term qSG since the economic value of the extracted reserve is determined by the proportion of the resource in the extracted material, as indicated by G.

Substituting equation (30) into equation (36) gives equation (37).

dΠ=(rᵢV−r₂Sγ_{S}−r₃γ_{F}F)dt−(qSG−ε)dt (37)

The rate of increase of the value of the resource V in a risk free portfolio, indicated as r₁ in equation (37), is given by the risk free interest rate r. The rate of increase of the part of the risk free portfolio γₛS, indicated by r₂ in equation (37) is given by the risk free interest rate minus the convenience yield associated with the part of the extracted resource (r−δ), given that the convenience yield indicates costs associated with holding the resource. Given that F is a call option to buy a share in the mine, the rate of increase of F, given by r₃, is equal to r. Substituting values for r₁, r₂ and r₃ into equation (37) gives equation (37a).

dΠ=(rV−(r−δ)Syₛ−ry_{F}F)dt−(qSG−ε)dt (37a)

Given that the left hand sides of equations (35) and (37a) are both equal to dΠ, the right hand sides of equations (35) and (37a) can be set to be equal to each other to give equation (38).

(a₂−γₛμS−γ_{F}a₃)dt=(rV−(r−δ)Sy_{S}−rγ_{F}F)dt−(qSG−ε)dt (38)

In order to derive equation (35) the terms γ_{F} and γₛ were given values γ_{F}=c₂/c₃ and γₛ=(b₂−γ_{F}b₃)σₛS. The values c₂, c₃, b₂ and b₃ are introduced in equations (29a) and (31a) as notational convenience for terms in equations (29) and (31). Substituting the corresponding terms in equations (29) and (31) gives equations (39) and (40):

$$\begin{matrix}{γ}_{F} = {c}_{2} / {c}_{3} = {σ}_{G} \sqrt{G} \frac{\partial V}{\partial G} / {σ}_{G} \sqrt{G} \frac{\partial F}{\partial G} = \frac{\partial V}{\partial G} / \frac{\partial F}{\partial G} & ( 39 ) \\ \begin{matrix}{γ}_{s} = ( {σ}_{s} S \frac{\partial V}{\partial S} - ( \frac{\partial V}{\partial G} / \frac{\partial F}{\partial G} ) {σ}_{s} S \frac{\partial F}{\partial S} ) / {σ}_{s} S \\ = \frac{\partial V}{\partial S} - ( \frac{\partial V}{\partial G} / \frac{\partial F}{\partial G} ) \frac{\partial F}{\partial S}\end{matrix} & ( 40 )\end{matrix}$$

Expanding the terms γ_{F} and γₛ in equation (38) and factoring out the time differential from each term gives equation (41):

$${a}_{2} - μ S ( \frac{\partial V}{\partial S} - ( \frac{\partial V}{\partial G} / \frac{\partial F}{\partial G} ) \frac{\partial F}{\partial S} ) - \frac{\partial V}{\partial G} / \frac{\partial F}{\partial G} {a}_{3} = rV - ( r - δ ) S ( \frac{\partial V}{\partial S} - ( \frac{\partial V}{\partial G} / \frac{\partial F}{\partial G} ) \frac{\partial F}{\partial G} ) - r \frac{\partial V}{\partial G} F / \frac{\partial F}{\partial G} - ( qSG - ɛ ) \qquad ( 41 )$$

Expanding the term a₂ for its corresponding term in equation (29), and multiplying through by μS and (r−δ)S gives equation (42):

$$( \begin{matrix}\frac{\partial V}{\partial t} - q \frac{\partial V}{\partial Q} + \frac{1}{2} {σ}_{s}^{2} {S}^{2} \frac{{\partial }^{2} V}{\partial {S}^{2}} + \\ μ S \frac{\partial V}{\partial S} + q \frac{1}{2} {σ}_{G}^{2} G \frac{{\partial }^{2} V}{\partial {G}^{2}} + qk ( α - G ) \frac{\partial V}{\partial G}\end{matrix} ) - \frac{\partial V}{\partial S} μ S + ( \frac{\partial V}{\partial G} / \frac{\partial F}{\partial G} ) \frac{\partial F}{\partial S} μ S - ( \frac{\partial V}{\partial G} / \frac{\partial F}{\partial G} ) {a}_{3} = rV - ( r - δ ) S \frac{\partial V}{\partial S} + ( r - δ ) S ( \frac{\partial V}{\partial G} / \frac{\partial F}{\partial G} ) \frac{\partial F}{\partial S} - r \frac{\partial V}{\partial G} F / \frac{\partial F}{\partial G} - ( qSG - ɛ ) \qquad ( 42 )$$

Cancelling the corresponding positive and negative

$$μ S \frac{\partial V}{\partial S}$$

terms gives equation (43):

$$( \frac{\partial V}{\partial t} - q \frac{\partial V}{\partial Q} + \frac{1}{2} {σ}_{s}^{2} {S}^{2} \frac{{\partial }^{2} V}{\partial {S}^{2}} + q \frac{1}{2} {σ}_{G}^{2} \frac{{\partial }^{2} V}{\partial {G}^{2}} + qk ( α - G ) \frac{\partial V}{\partial G} ) + ( \frac{\partial V}{\partial G} / \frac{\partial F}{\partial G} ) \frac{\partial F}{\partial S} μ S - ( \frac{\partial V}{\partial G} / \frac{\partial F}{\partial G} ) {a}_{3} = rV - ( r - δ ) S \frac{\partial V}{\partial S} + ( r - δ ) S ( \frac{\partial V}{\partial G} / \frac{\partial F}{\partial G} ) \frac{\partial F}{\partial S} - r \frac{\partial V}{\partial G} F / \frac{\partial F}{\partial G} - ( qSG - ɛ ) \qquad ( 43 )$$

Equation (43) can be rearranged to give equation (44):

$$\frac{1}{2} {σ}_{s}^{2} {S}^{2} \frac{{\partial }^{2} V}{\partial {S}^{2 }} + q \frac{1}{2} {σ}_{G}^{2} G \frac{{\partial }^{2} V}{\partial {G}^{2}} + \frac{\partial V}{\partial t} - q \frac{\partial V}{\partial Q} + ( r - δ ) S \frac{\partial V}{\partial S} + qk ( α - G ) \frac{\partial V}{\partial G} - rV + qSG - ɛ = ( r - δ ) S ( \frac{\partial V}{\partial G} / \frac{\partial F}{\partial G} ) \frac{\partial F}{\partial S} - r \frac{\partial V}{\partial G } F / \frac{\partial F}{\partial G} - ( \frac{\partial V}{\partial G} / \frac{\partial F}{\partial G} ) \frac{\partial F}{\partial S} μ S + ( \frac{\partial V}{\partial G} / \frac{\partial F}{\partial G} ) {a}_{3} \qquad ( 44 )$$

Each of the terms on the right hand side of equation (44) contains a factor

$$\frac{\partial V}{\partial G} .$$

### Factoring out

$$\frac{\partial V}{\partial G}$$

gives equation (45):

$$\frac{1}{2 } {σ}_{s}^{2} {S}^{2} \frac{{\partial }^{2} V}{\partial {S}^{2}} + q \frac{1}{2 } {σ}_{G}^{2} G \frac{{\partial }^{2} V}{\partial {G}^{2}} + \frac{\partial V}{\partial t} - q \frac{\partial V}{\partial Q} + ( r - δ ) S \frac{\partial V}{\partial S} + qk ( α - G ) \frac{\partial V}{\partial G} - rV + qSG - ɛ = \frac{\partial V}{\partial G} ( \begin{matrix}( r - δ ) S ( \frac{\partial F}{\partial S} / \frac{\partial F}{\partial G} ) - rF / \frac{\partial F}{\partial G} - \\ ( \frac{\partial F}{\partial S} μ S / \frac{\partial F}{\partial G} ) + {a}_{3} / \frac{\partial F}{\partial G}\end{matrix} ) \qquad ( 45 )$$

For algebraic convenience σ_{G}λ_{G} is defined according to equation (46):

$${σ}_{G} {λ}_{G} = ( r - δ ) S ( \frac{\partial F}{\partial S} / \frac{\partial F}{\partial G} ) - rF / \frac{\partial F}{\partial G} - ( \frac{\partial F}{\partial S} μ S / \frac{\partial F}{\partial G} ) + {a}_{3} / \frac{\partial F}{\partial G} \qquad ( 46 )$$

Substituting the definition of σ_{G}λ_{G} of equation (46) into equation (45) gives equation (47).

$$\frac{1}{2} {σ}_{s}^{2} {S}^{2} \frac{{\partial }^{2} V}{\partial {S}^{2}} + q \frac{1}{2} {σ}_{G}^{2} G \frac{{\partial }^{2} V}{\partial {G}^{2}} + \frac{\partial V}{\partial t} - q \frac{\partial V}{\partial Q} + ( r - δ ) S \frac{\partial V}{\partial S} + q ( k ( α - G ) - {σ}_{G} {λ}_{G} ) \frac{\partial V}{\partial G} - rV + qGS - ɛ = 0 \qquad ( 47 )$$

where σ_{G}λ_{G} is the market price of risk.

Substituting \hat{α}=α−σ_{G}λ_{G}/k into equation (47) and making the substitution τ=T−t gives equation (48) below.

$$\frac{1}{2} {σ}_{s}^{2} {S}^{2} \frac{{\partial }^{2} V}{\partial {S}^{2}} + q \frac{1}{2} {σ}_{G}^{2} G \frac{{\partial }^{2} V}{\partial {G}^{2}} - \frac{\partial V}{\partial τ} - q \frac{\partial V}{\partial Q} + ( r - δ ) S \frac{\partial V}{\partial S} + qk ( \hat{α} - G ) \frac{\partial V}{\partial G} - rV + qGS - ɛ = 0 \qquad ( 48 )$$

Equation (48) is a model M of the stochastic function V(S, G, Q, t) in which the variables S and G are stochastic variables. The model M of equation (48) has boundary conditions (48.1), (48.2) and (48.3) corresponding to boundary conditions (14.1), (14.2) and (14.3) for the model M of equation (14) as below:

V=0 on Q=0 (48.1)

V→mS+c as S→∞ (48.2)

where m is a function of the form A(G,Q,t) and c is a function of the form B(G,Q,t) and each of A and B evaluate to a constant in S (as described above with reference to equation (14.2);

V=0 at t=T (48.3)

The model M of equation (48) additionally has boundary conditions on G that the behaviour of the model is convection dominated as the value of G moves far from its mean. Equation (48) is therefore solved with second derivatives of G becoming insignificant as the term (α−G) in equation (25) becomes large. This implies that G is unlikely to move far from its mean. This is a standard approach used in solving partial differential equations with mean-reverting processes. More specifically, as G tends to zero, the model (48) tends to (48.4) below.

$$\frac{1}{2} {σ}_{s}^{2} {S}^{2} \frac{{\partial }^{2} V}{\partial {S}^{2}} - \frac{\partial V}{\partial τ} - q \frac{\partial V}{\partial Q} + ( r - δ ) S \frac{\partial V}{\partial S} + qk \hat{α} \frac{\partial V}{\partial G} - rV - ɛ = 0 \qquad ( 48.4 )$$

As G tends to infinity, the model (48) tends to (48.5).

$$\frac{1}{2} {σ}_{s}^{2} {S}^{2} \frac{{\partial }^{2} V}{\partial {S}^{2}} - \frac{\partial V}{\partial τ} - q \frac{\partial V}{\partial Q} + ( r - δ ) S \frac{\partial V}{\partial S} + qk ( \hat{α} - G ) \frac{\partial V}{\partial G} - rV + SGq - ɛ = 0 \qquad ( 48.5 )$$

Boundary conditions (48.4) and (48.5) indicate that the stochastic process modelled by equation (48) does not deviate far from its mean level as G varies.

Whilst it has been described above that the random term associated with grade G is hedged using call options to buy a share in the resource, it will be appreciated that other financial contracts which include grade uncertainty may be used. For example, grade uncertainty can be hedged using options on futures contracts or options on forward contracts.

Referring now to FIG. 4, at step S6 the model M, given by Equation (48), is received and at step S7 the control equation C is derived from M by differentiating Equation (48) with respect to q and setting

$$\frac{\partial V}{\partial q} = 0.$$

The control equation C is given by Equation (49).

$$- \frac{\partial V}{\partial Q} + \frac{1}{2} {σ}_{G}^{2} G \frac{{\partial }^{2} V}{\partial {G}^{2}} + k ( \hat{α} - G ) \frac{\partial V}{\partial G} + SG - \frac{\partial ɛ}{\partial q} = 0 \qquad ( 49 )$$

Referring now to FIG. 5, at step S10 a directional derivative is defined as before, and as given by Equation (11). Equation (48) is rearranged and the directional derivative of Equation (18) is substituted in to Equation (48) to give Equation (50) below.

$$\frac{DV}{D τ} = \frac{1}{2} {σ}_{s}^{2} {S}^{2} \frac{{\partial }^{2} V}{\partial {S}^{2}} + q \frac{1}{2} {σ}_{G}^{2} G \frac{{\partial }^{2} V}{\partial {G}^{2}} + ( r - δ ) S \frac{\partial V}{\partial S} + qk ( \hat{α} - G ) \frac{\partial V}{\partial G} - rV + qGS - ɛ \qquad ( 50 )$$

By definition L_{S}{V} and L_{G}{V} are given by Equations (51) and (52) respectively.

$$\begin{matrix}{L}_{S} \{ V \} ≡ \frac{1}{2} {σ}_{s}^{2} {S}^{2} \frac{{\partial }^{2} V}{\partial {S}^{2}} + ( r - δ ) S \frac{\partial V}{\partial S} - rV & ( 51 ) \\ {L}_{G} \{ V \} ≡ \frac{1}{2} {σ}_{G}^{2} G \frac{{\partial }^{2} V}{\partial {G}^{2}} + ( k ( α - G ) - {σ}_{G} {λ}_{G} ) \frac{\partial V}{\partial G} & ( 52 )\end{matrix}$$

Substituting Equation (51) and Equation (52) for corresponding terms in Equation (50) gives a notational simplification of the model M of Equation (48), given by Equation (53) below.

$$\frac{DV}{D τ} = {L}_{S} \{ V \} + {qL}_{G} \{ V \} + qGS - ɛ \qquad ( 53 )$$

The control equation of Equation (49) may also be notationally simplified by substituting Equation (42) for corresponding terms to give Equation (54).

$$\frac{\partial ɛ}{\partial q} = - \frac{\partial V}{\partial Q} + {L}_{G} \{ V \} + SG \qquad ( 54 )$$

At step S11 a grid spacing Δ is selected in the same way as for the one factor model, according to the characteristic line Q=qₘₐₓτ such that ΔQ=qₘₐₓΔt. The grid spacing Δ indicates a distance between nodes of an equally spaced grid in S, Q, τ and G so that Sᵢ=iΔS, Q=jΔQ, τₖ=kΔT and G₁=lΔG. The right-hand side of Equation (53) can be expressed with standard finite differences at nodes in the grid since the position of each term on the right-hand side is independent of any variables. Since the left-hand side depends on the value of q which is not a constant the left-hand side of Equation (53) in general takes values not situated on a standard grid node. Any term that depends upon q therefore cannot always be placed on a fixed grid so that values at the left-hand side generally require interpolation.

At step S12 an iterative scheme is generated. An iterative scheme corresponding to Equations (53) and (54) is given by Equations (55) and (56) below, where Equation (53) is written as:

$$\frac{{V}_{i , j , l}^{k} - V ( {S}_{i} , {Θ}_{i , j}^{k - 1} , {τ}_{k - 1} , {G}_{l} )}{Δτ} = {L}_{S} \{ {V}_{i , j , l}^{k} \} + {\hat{q}}_{i , j , l}^{k} {L}_{G} \{ {V}_{i , j , l}^{k} \} + {\hat{q}}_{i , j , l}^{k} {G}_{1} {S}_{i} - ɛ ( {\hat{q}}_{i , j , l}^{k} , {Q}_{j} , {τ}_{k} , {G}_{l} ) \qquad ( 55 )$$

where:
V_{i,j,l}^{k}=V(Sᵢ,Qⱼ,τₖ,Gₗ);
\hat{q}_{i,j,l}^{k}=\hat{q}(Sᵢ,Qⱼ,τₖ,Gₗ);
\hat{q} indicates an updated value of q;
Θ_{i,j}^{k} is an equation of a characteristic line that satisfies the condition that the line arrives at a point Qⱼ at time τₖ, assuming that q is constant across τε(τₖ₋₁,τₖ) and is given by Θ_{i,j}^{k}=Qⱼ+q_{i,j,l}^{k}(τ−τₖ); and
ε is a single valued function.

Note that it may be necessary to determine the value V(Sᵢ,Θ_{i,j}^{k-1},τₖ, Gₗ) by linear interpolation where (Sᵢ,Θ_{i,j}^{k-1},τₖ, Gₗ) does not coincide with a node of the discretised system.

Equation (54) is written as:

$$f ( {q}_{i , j , l}^{k} ) = \frac{{\hat{V}}_{i , j , l}^{k} - {\hat{V}}_{i , j - 1 , l}^{k}}{Δ Q} + {L}_{G} \{ {V}_{i , j , l}^{k} \} + {S}_{i} {G}_{l} \qquad ( 56 )$$

where:
f is an invertible function given by f=dc/dq;
q_{i,j,l}^{k}=q(SᵢQⱼ,τₖ,Gₗ);
\hat{V}_{i,j,l}^{k}=\hat{V}(Sᵢ,Qⱼ,τₖ,Gₗ); and
\hat{V} indicates an updated value of V.

In each of Equations (55) and (56), q and \hat{q} are in the range qₘᵢₙ and qₘₐₓ.

It may further be desirable to model V where V is a stochastic function V(S, δ, r, Q, t) in which S, δ and r are each stochastic variables, for example where δ and r indicate convenience yield and interest rate respectively. A model of a three factor stochastic function may be generated according to the processing of FIG. 3 as set out below.

At step S1 the parameters affecting the model are selected. As described above the stochastic function V(S, δ, r, Q, t) has as its parameters S, δ, r, Q and t of which three variables are stochastic. At step S2 the behaviour of the parameters are defined. The behaviour of S is as defined in equation (1). In the case where δ indicates a convenience yield and r indicates an interest rate each of these may be modelled by a risk adjusted mean-reverting Brownian process according to Equations (57) and (58) respectively.

dδ=k(α−δ−σ_{c}λ_{c})dt+σ_{c}SdX_{c} (57)

dr=l(m−r−σᵣλᵣ)dt+σᵣSdXᵣ (58)

### Where:

k(α−δ) and l(m−r) are the drifts of δ and r respectively;
σ_{c} and σᵣ are the volatilities of δ and r respectively;
λ_{c} and λᵣ are the market price of risk for δ and r respectively; and
X_{c} and Xᵣ are random variables associated with δ and r respectively and are each normally distributed as N(0, √dt).

At step S3 a model of the behaviour V(S, δ, r, Q, t) is generated using Itō's Lemma and at step S4 random terms Xₛ, X_{c} and Xᵣ generated using Itō's Lemma are removed by carefully subtracting appropriate amounts of dXₛ, dX_{c} and dXᵣ. Random terms X_{c} and Xᵣ cannot be removed by selling amounts of r and δ as is possible for S, however these terms can be removed by selling appropriate financial instruments which are functions of r and δ. For example one way of removing the term Xᵣ is by selling government bonds, since a government bond equation can be expressed as dB=\hat{B}dt +BᵣdXᵣ which contains a term dependent upon Xᵣ. An appropriate amount of B may therefore be sold to hedge away the term Xᵣ. Hedging away Xᵣ and X_{c} in this way may introduce additional terms and these terms are captured in equations (57) and (58) by λ_{c} and λᵣ.

A three stochastic factor valuation model for V(S, δ, r, Q, t) can be derived using Ito's lemma in a similar manner to that described above for the one and two stochastic factor valuation models and is given by equation (59).

$$\frac{1}{2} {σ}_{s}^{2} {S}^{2} \frac{{\partial }^{2} V}{\partial {S}^{2}} + \frac{1}{2} {σ}_{c}^{2} \frac{{\partial }^{2} V}{\partial {δ}^{2}} + \frac{1}{2} {σ}_{r}^{2} \frac{{\partial }^{2} V}{\partial {r}^{2}} + {σ}_{s} {σ}_{c} {ρ}_{sc} S \frac{{\partial }^{2} V}{\partial S \partial δ} + {σ}_{s} {σ}_{cr} {ρ}_{rs} S \frac{{\partial }^{2} V}{\partial S \partial r} + {σ}_{c} {σ}_{r} {ρ}_{cr} \frac{{\partial }^{2} V}{\partial δ \partial r} + \frac{\partial V}{\partial t} - q \frac{\partial V}{\partial Q} + ( r - δ ) S \frac{\partial V}{\partial S} + ( k ( α - δ ) - {σ}_{c} {λ}_{c} ) \frac{\partial V}{\partial δ} + ( 1 ( m - r ) - {σ}_{r} {λ}_{r} ) \frac{\partial V}{\partial r} rV + Sq - ɛ = 0 \qquad ( 59 )$$

### Where:

ρ_{sc}, ρᵣₛ and ρ_{rc} are respectively the correlation between price and convenience yield, correlation between interest rate and price and correlation between interest rate and convenience yield. At step S5 the model M given by equation (59) is output. As described above, the model of equation (59) is created in the same manner as the models of equations (14) and (48), by creating a risk-free portfolio which owns the resource with valuation V and is short three financial instruments, each financial instrument being a function of one of the three stochastic uncertainties of the model.

Although the above derivation of a three stochastic factor valuation model has been described with respect to price, convenience yield and interest rate, it will be appreciated that the methods described are applicable to other combinations of stochastic variables, for example including grade uncertainty G as described above.

The methods described above are generally concerned with determining and optimising the resource value 5 based upon endogenous factors such as a rate of extraction of the resource while taking into account stochastic and endogenous factors. It is described above that two boundary conditions exist at which the value of the mine V=0. In particular, boundary condition (14.1) described above indicates that when the reserve is exhausted, that is when Q=0, the value of the reserve is zero. Additionally, boundary condition (14.2) described above indicates that when an end time T is reached, indicating that no further time remains for extracting the resource such as at the expiry of a contract, the value of the resource is also zero.

In some embodiments the extraction rate may be constant but it may be possible to stop extraction of a resource upon payment of an associated cost A of abandonment before time T or before Q=0. For example, if price S of the resource drops below a certain value, extraction of the resource may no longer be cost effective such that it is preferable to stop extraction and close the extraction operation, or put the operation on hold until the price S is sufficient to make extraction cost effective. It is therefore desirable to be able to determine an expected lifetime of extraction indicating a time in which continuing extraction is preferable to stopping extraction.

It is further desirable to be able to determine a value of the price S at which stopping extraction is preferable to continuing extraction. Methods for determining factors relating to an expected lifetime of extraction will therefore now be described.

In the above description the model M of equation (14) is derived by creating a financial portfolio Π which has value V and which is short a₁ units at a price S. In this way, uncertainty in the portfolio is hedged away. The following method to derive a model applies probabilistic methods to obtain a modified Feynman-Kac equation. The modified Feynman-Kac equation is a general model of a resource under price uncertainty which forms the basis for modelling a valuation of the resource which is equivalent to the model M of equation (14), and also allows an expected lifetime of extraction of the resource and a probability of completion of extraction to be modelled. Models for each of valuation, expected lifetime of extraction and probability of completion of extraction are generated from the modified Feynman-Kac equation by selection of values for functions and constants specific to the modelled condition.

The model of the valuation of the resource can be processed to determine an abandonment surface S*(Q, t), at and beyond which continuing extraction is no longer cost effective such that extraction of the resource should be abandoned. The determined surface S*(Q,t) can be used as a boundary condition in the models of expected lifetime of extraction of the resource and probability of completion of extraction to determine further useful information associated with the resource.

In more detail, it is known from Øksendal, B.: “Stochastic differential equations”, 5^{th} edn, Springer (2003), Berlin, Germany, that a general class of expectations for a quantity u of the form (60) below is a solution to a problem of the form shown in Equation (61) below.

u(x)=Eₓ[e^{-cv}ƒ(Xᵥ)+∫₀^{v}e^{-cu}g(Xᵤ)du] (60)

where:
ƒ and g are functions to be defined based upon the modelled quantity;
c is a constant to be defined based upon the modelled quantity;
Xₜ is an Ito diffusion in Rⁿ;
v is the first time that Xₜ exits the solution domain H;
Eₓ denotes the expected value when X₀=xεRⁿ; and
n is the number of variables modelled by u.

$$\begin{matrix}Lu ( x ) - cu ( x ) = - g ( x ) & in H \\ {lim}_{x \to y} u ( x ) = f ( y ) & for y ∈ \partial H\end{matrix} \} \qquad ( 61 )$$

where:
L is as shown in Equation (62) and [αᵢⱼ]=½σσ′.

$$L ≡ {\sum }_{ij = 1}^{n} {a}_{ij} \frac{{\partial }^{2}}{\partial {x}_{i} \partial {x}_{j}} + {\sum }_{i = 1}^{n} {b}_{i} \frac{\partial }{\partial {x}_{i}} \qquad ( 62 )$$

We consider below the case where u is a function of (S, Q t) where S, indicating price, is the only stochastic variable. The Ito diffusion Xₜ of Equation (60) is therefore in R³ where time t is modelled as a trivial stochastic process, dt=1.dt+0.dB and size of resource Q is modelled as dQ=−q.dt+0.dB. Price S is modelled as a geometric Brownian motion as set out in Equation (1).

It will however be appreciated that equations (61) and (62) can similarly be applied where u is dependent upon more than one stochastic variable by modelling the variables appropriately, for example by modelling grade uncertainty G as well as price uncertainty S, as set out above.

The formulation of equations (60) and (61) is sufficiently general to represent the quantity u as a valuation of the mine V(Sₜ, Qₜ, t), a probability of completion P(Sₜ, Qₜ, t) or an expected lifetime of extraction D(Sₜ, Qₜ, t), where (Sₜ, Qₜ, t) is a particular point in time of the solution domain H. In each case the parameter c and functions ƒ and g are chosen appropriately for the problem, where in each case the parameter c is the (possibly zero) constant discount rate appropriate to the problem, ƒ is the boundary value of the solution and g is the instantaneous source term appropriate to the problem, for example indicating cashflow in a valuation of a resource. That is, the solution u is the expectation of the boundary value c, where Xₜ exits the solution space H, plus accumulated source terms, under appropriate discounting.

The boundary of the solution space H is described by the two planes t=T and Q=0, as described above corresponding to expiry of time available for extraction of the resource and exhaustion of the resource respectively, the far-field condition as S→∞ and the price surface of abandonment denoted S*(Q, t).

For each of u=V, P and D set out above, Equation (61) can be rewritten in the form shown in Equation (63) below which provides the modified Feynman-Kac equation:

$$\frac{1}{2} {σ}^{2} {S}^{2} \frac{{\partial }^{2} u}{\partial {S}^{2}} - \frac{\partial u}{\partial τ} - q \frac{\partial u}{\partial Q} + μ S \frac{\partial u}{\partial S} - cu + g = 0 \qquad ( 63 )$$

where τ=T−t.

Equation (63) holds throughout the solution domain H, subject to the boundary conditions that relate to the abandonment surface, far-field conditions and expiry and exhaustion of the mine, determined by ƒ at these states.

As indicated above, the general Equation (63) for a quantity u can be used to represent the quantity u as a valuation of the mine V(Sₜ, Qₜ, t), a probability of completion P(Sₜ, Qₜ, t) or an expected lifetime of extraction D(Sₜ, Qₜ, t), where (Sₜ, Qₜ, t) is a particular point in time of the solution domain H. The values c, ƒ and g in Equation (63) for each of u=P, V and D will now be considered in turn where, as set out above, the parameter c is the (possibly zero) constant discount rate appropriate to the problem, ƒ is the boundary values of the solution and g is the instantaneous source term appropriate to the problem.

Turning first to the case where u=P, Equation (63) models a probability of completion. Given that P is not concerned with a monetary value, the constant discount rate c=0. Additionally g can be set to a value 0 as no source term is considered. The boundary value of P=0 occurs when extraction is abandoned, that is where S=S* completion cannot occur. The boundary value of P=1 occurs where t=T, Q=0 and as S∫∞, that is the mine is not abandoned where the term of the lease expires, the resource runs out and as the price becomes very large. As such, Equation (63) for u=P is given by Equation (64):

$$\frac{1}{2} {σ}^{2} {S}^{2} \frac{{\partial }^{2} P}{\partial {S}^{2}} - \frac{\partial P}{\partial τ} - q \frac{\partial P}{\partial Q} + μ S \frac{\partial P}{\partial S} = 0 \qquad ( 64 )$$

subject to:
P=0 on S=S*;
P=1 when min {Q,τ}=0; and
P→1 as S→∞.

Turning next to the case where u=D, Equation (63) models an expected lifetime of extraction. Given that D is not concerned with a monetary value and there are no source terms present, the constant discount rate c=0 and the source term g=0. The boundary value of D=T occurs where τ=0 and as S→∞, that is the lifetime of extraction is equal to the length of lease when t is equal to T and where price tends becomes very large. The boundary value of D=T−τ occurs where Q=0 or where S−S*=0, that is the lifetime of extraction has expired at the current time where the resource is expended or where the price lies on the surface of abandonment. As such, Equation (63) for u=D is given by Equation (65):

$$\frac{1}{2} {σ}^{2} {S}^{2} \frac{{\partial }^{2} D}{\partial {S}^{2}} - \frac{\partial D}{\partial τ} - q \frac{\partial D}{\partial Q} + μ S \frac{\partial D}{\partial S} = 0 \qquad ( 65 )$$

subject to:
D=T−τ when min {S−S*, Q}=0;
D=T when τ=0; and
D→T as S→∞.

Finally where u=V, Equation (63) models the value of the mine. In this case, given that V is concerned with a monetary value the constant discount rate is equal to the interest rate, c=r, as in the methods described previously. The source terms comprise costs incurred ε and revenues arising from the amount of saleable resource qGS, where G is the amount of saleable resource per unit extracted and can be expressed as a function of Q since random variation in resource grade is suppressed, that is grade quality is modelled as a non-stochastic variable. Costs ε may include extraction costs εₘ and processing costs for refining the resource εₚ, each of which can be expressed as a function of Q. Where processing an extracted resource is not economically beneficial, that is where costs associated with processing the resource are higher than the value of the resource qGS, processing of the resource may be avoided so that costs associated with processing may be expressed as max(0, qGS−εₚ). As such, g has the form max(0, qGS−εₚ)−εₘ.

The values of ƒ indicating the limits of the value of the mine will be 0 when any of S−S*, τ and Q are equal to 0, that is where the resource is abandoned, no time is remaining and the resource is empty respectively. As extraction rate q has a physical upper bound and extraction costs also are bounded, the value of the resource V will grow linearly in S for large S providing the far-field boundary condition. As such, Equation (63) for u=V is given by Equation (66):

$$\frac{1}{2} {σ}^{2} {S}^{2} \frac{{\partial }^{2} V}{\partial {S}^{2}} - \frac{\partial V}{\partial τ} - q \frac{\partial V}{\partial Q} + μ S \frac{\partial V}{\partial S} - rV + max ( 0 , q \overline{G} S - {ɛ}_{p} ) - {ɛ}_{m} = 0 \qquad ( 66 )$$

subject to:
V=0 when min {S−S*, τ, Q}=0; and
V˜S as S→>0.

Equation (66) can be seen to correspond to the risk-free model M of Equation (14) with the described alternative formulation of qS−ε. It will be appreciated that the alternative formulation can similarly be modelled as qS−ε if desired. It can be seen that the risk-free model M of Equation (14) differs from the formulation of Equation (66) in the formulation of the drift μ, which has the form μ=r−δ in Equation (14). The substitution μ=r−δ can be made in each of equations (64), (65) and (66) where it is known that hedging can be performed, as used in the model of Equation (14) above, or alternatively the real-world drift can be determined from historical data and used.

The surface of abandonment, S*=S*(Q, t), lies at those positions where V(S, Q, t)=A, where A is some value at which the resource is no longer valuable. For example, the value A may be a value of 0 indicating that the mine no longer has any value, or may be some value indicative of the costs of abandoning the resource, such that the resource is abandoned when the value of the resource no longer exceeds the costs associated with the resource. Accordingly, the option to abandon satisfies the condition V(S, Q, t)≧max(V′, 0), where V′ is the solution to the mine valuation (66) without an option to abandon. That is, the value of the option to abandon is greater than or equal to the value of a regime that is always extracting and the value of a mine that has been abandoned (i.e. 0 in the case where A=0).

The above problem for determining the surface of abandonment S* is non-linear. Given the equivalence of Equation (66) and Equation (14) it will be appreciated that Equation (66) can be re-written as a semi-Lagrangian numerical scheme corresponding to Equation (23) above. Since an option to abandon the resource is included, the problem is a constrained matrix problem with condition V_{i,j}^{k}≧0, and boundary conditions set out above for Equation (66). A valuation V can therefore be determined using Equation (23) for all points in the solution space, for example using a projected successive over relaxation method, which is a standard numerical approach and is described for example in Wilmott, P., Howison, S., & Dewynne, J.: “The mathematics of financial derivatives”, 1995, Cambridge University Press, Cambridge, UK.

The valuations V for each point in the solution space can be used to determine the surface of abandonment S*(Q, t) by determining those values of S for which V(S, Q, t)=−A, where A is the cost associated with abandonment. The determined values of S for which V(S, Q, t)=−A define the surface of abandonment. That is, the surface of abandonment S*(Q, t) is found by determining the root of V(S*, Q, t)=−A.

As indicated above, the determined surface of abandonment S*(Q,t) provides boundary conditions for Equations (64) and (65). Semi-Lagrangian numerical schemes can be determined for each of Equations (64) and (65) in a corresponding manner to that described above to derive the numerical scheme of Equation (23) and the boundary conditions of Equations (64) and (65) can be used as starting positions for incrementally determining values of P and D for each point in the solution space H.

As set out above, a valuation V, probability of abandonment P, and expected lifetime D can be determined for each point (S, Q, t) in a solution space H(S, Q, t). The values of V, P and D can be used to provide useful information relating to a resource. For example, at a particular time t, the size of the resource Q and price S will in general be known and as such the value of the resource at that time t can be determined using the method described above. Additionally, the probability of the resource being abandoned can be determined and the expected lifetime of the resource can also be determined and such information can be used to make effective decisions relating to the resource.

It will be appreciated that various techniques can be used to approximate model parameters of the above models. Appendix 1 hereto, for example, provides a closed-form solution for the model of equation (64) above.

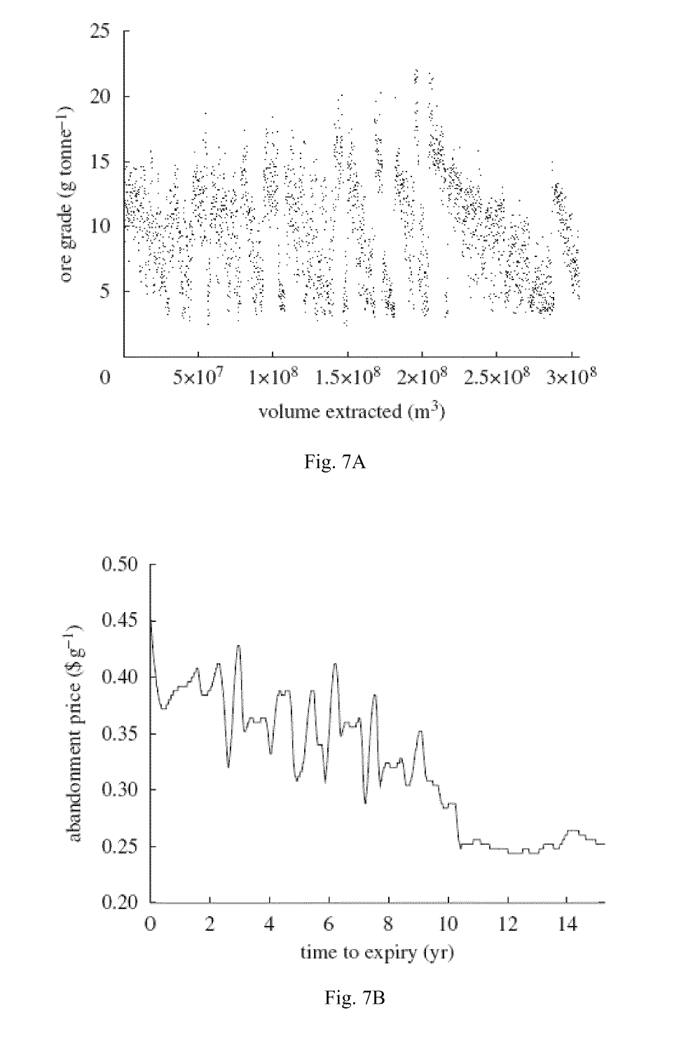

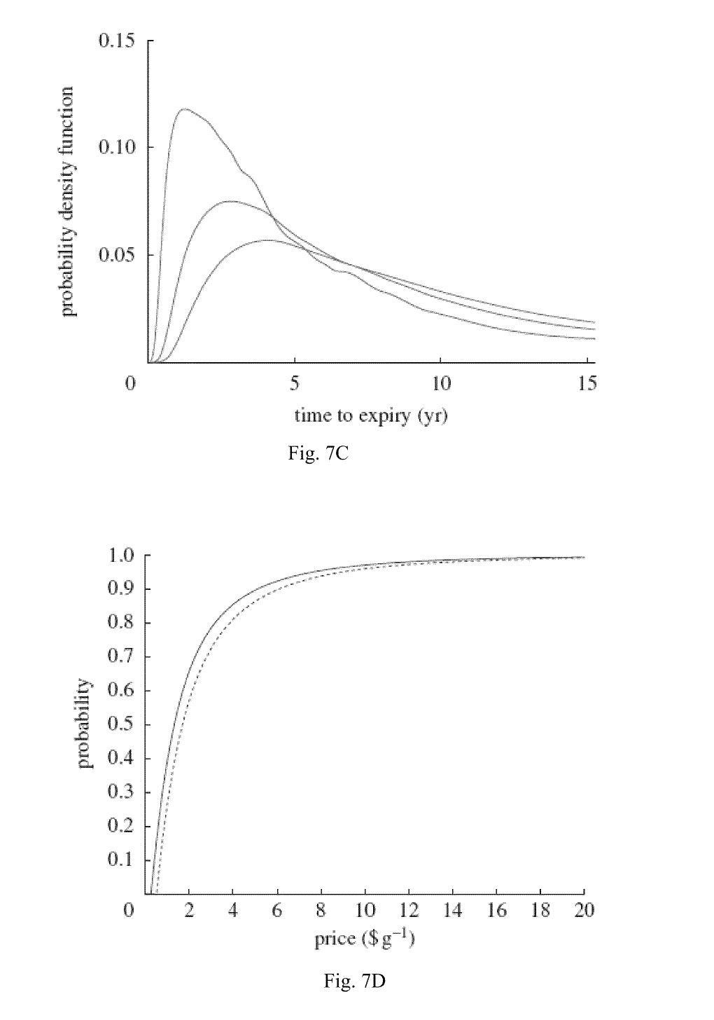

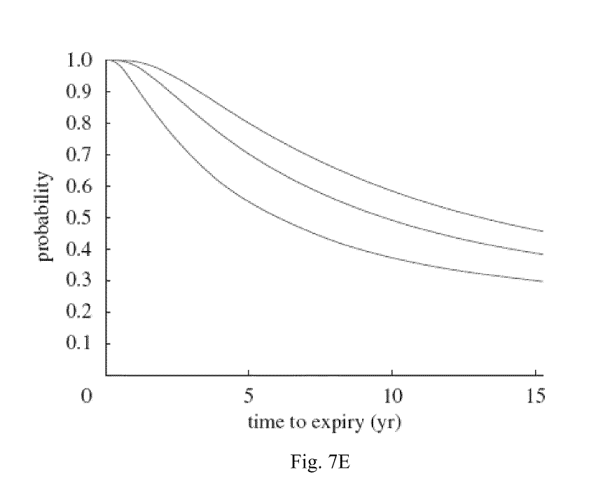

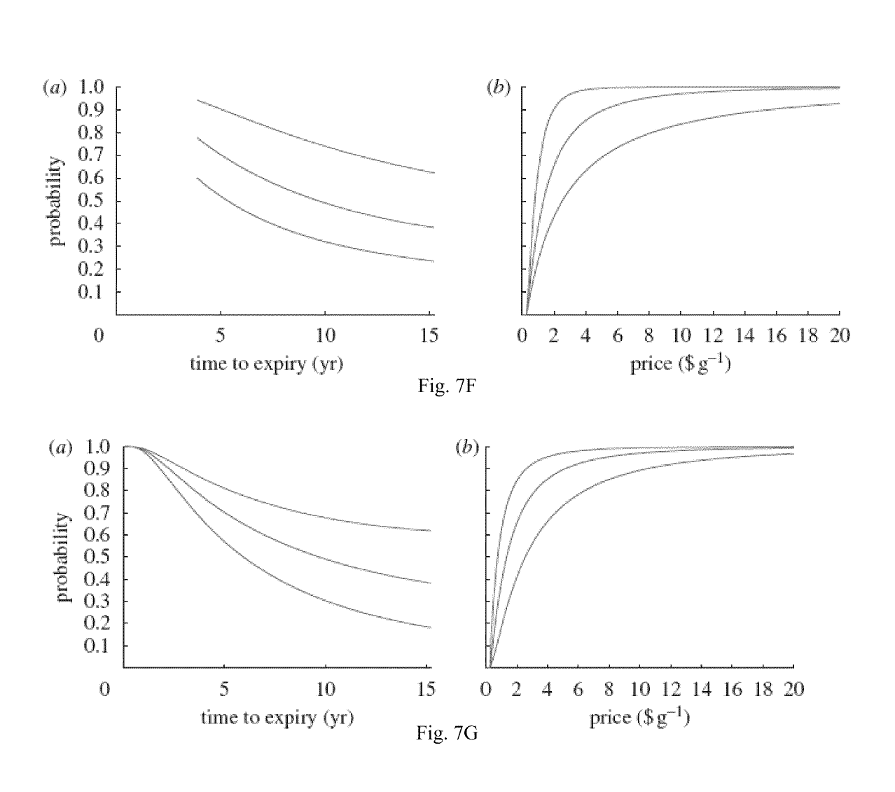

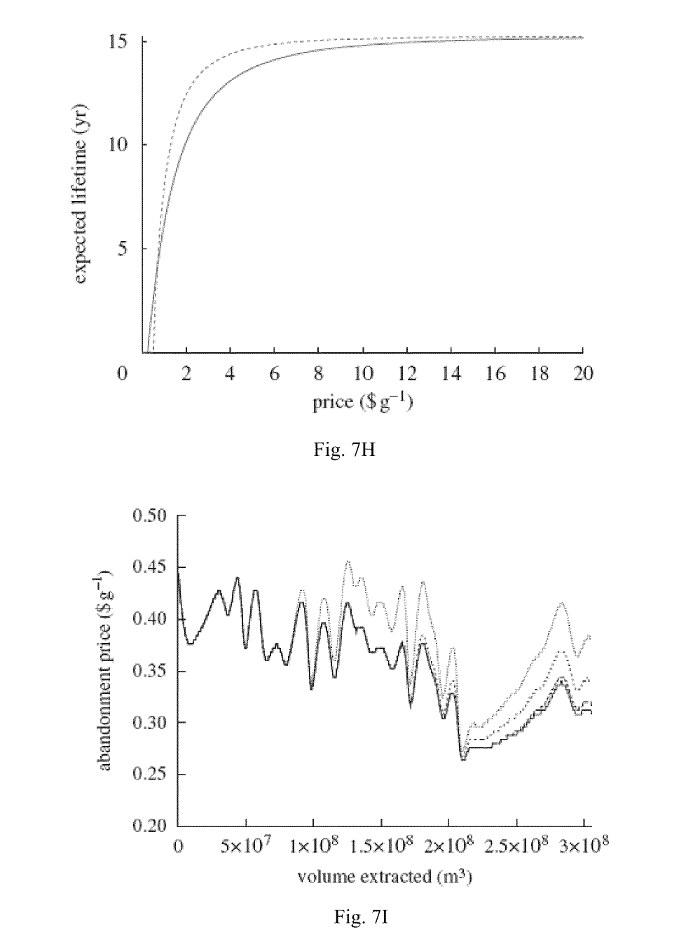

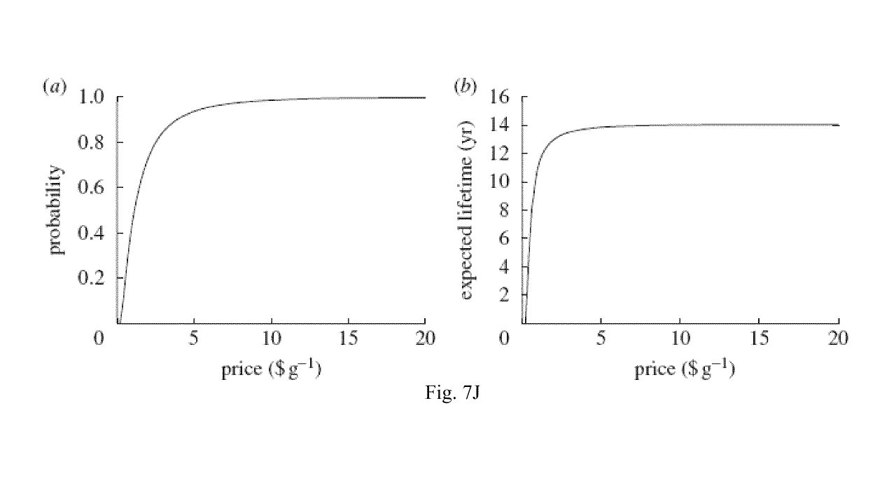

The method described above has been applied to a real mine dataset composed of 30000 data points. The annual processing capacity is set at 20,000,000 ore-bearing tonnes yr⁻¹, the cost of extraction, εₘ, is set at $1 tonne⁻¹, and the processing cost, εₚ, is $4 tonne⁻¹. FIG. 7A shows how the ore grade, G, varies throughout the path of extraction, having an average level of 9.74 g tonne⁻¹. Numerically, when more than one piece of measured ore-grade data lies between two solution nodes of Q, it is the average value of those particular ore grades which is used in the region around that point in Q. As such, one may think of use of the ore-grade data as a localized moving average as one passes along the path of extraction. The final parameter values used are given by r=10% yr⁻¹, d=10% yr⁻¹, CS =30% yr^{-1/2}.

In a first case, extraction rate is set to a constant rate of 20,000,000 ore-bearing tonnes yr⁻¹, which gives a maximum possible lifetime of 15.3 years. The resulting abandonment level, S*, is shown in FIG. 7B, which has been calculated numerically based upon (23). The reason why this figure is one-dimensional, as opposed to a surface, is that in this particular mine example the processing rate is fixed, and therefore the size of Q is a known value which can be determined a priori at all points in time prior to abandonment, and therefore S* depends only on time. As can clearly be seen, this particular solution of S* exhibits a relatively large degree of variation, and it can be expected that this variation passed into the solutions when looking at prices near the abandonment surface.

Using the numerically derived abandonment surface given by FIG. 7B, probability density functions (PDFs) for P are calculated as shown in FIG. 7C, this calculation is carried out for three underlying prices, S=0.8, S=1 and S=1.2. As can be seen, the closeness of the commodity price, S, to the abandonment price is reflected in the degree of variation of the PDF, as the roughness of the abandonment surface has not yet negligibly diffused out for smaller price values. In addition, the lower the price is, the shorter the modal time to expiry (maxima of PDFs) becomes, as expected.

The probability of completion is shown in FIGS. 7D and 7E, where the absence of the Q derivative a regular implicit finite difference scheme to be used as described above. As can be seen from FIG. 7D (solid line), the solution undergoes a rapid period of change up to (approx.) $4 g⁻¹, and thereafter has an 85 percent probability of completion. FIG. 7E shows how the probability of remaining open until expiry varies during extraction. This is shown for three different underlying prices: bottom to top, S=0.8, S=1 and S=1.2. The figure shows that, for higher prices, the probability through time exhibits less curvature and approximately follows a near linear path between the initial probability and P=1 at expiry.

FIG. 7D also shows how the real-data numerical result (solid line) compares with closed-form solution, which assumes a constant abandonment price (dashed line) over the remaining life of the mine. The two solutions exhibit a similar behaviour, where the key difference is a consequence of how the initial position of abandonment, S*(t=0), compares with that of the averaged position, Ŝ. This is indeed a limiting factor for the approximation, since, if the two positions were the same, the exact and approximate solutions would lie at the same point.

FIG. 7F shows how the probability varies for three different values of s, from top to bottom, 20 percent, 30 percent and 40 percent. FIG. 7F(lhs) shows the probability variation with price, and FIG. 7F(rhs) shows variations of time to expiry, where an increase in volatility, increases the probability of closure. Although the forms of the solution remain similar, even by varying the volatility by an absolute amount of 10%, the probability alters quite strongly, where increases in s have a larger proportional effect than decreases. This is to be expected since, strictly speaking, the solution depends upon σ², not σ.

The sensitivity to the risk-adjusted drift, r−δ, is shown in FIG. 7G. From top to bottom, the value of r−δ is 5 percent, 0 percent and −5 percent, where lower values of the risk-adjusted drift reduce the probability of remaining open. This makes intuitive sense, since if the risk-adjusted price was, on average, following a lower trajectory we would expect the probability of it hitting the level of abandonment to be increased.

The expected time of closure (or first passage) is shown in FIG. 7H. The solid line is, once again, the numerical solution to Equation (65), and the dashed line is the approximation under the assumption of a constant abandonment price. The results show a reasonable relationship between the two (albeit not as close as in the probability case), with the approximation having a greater curvature. The expected life of the mine exceeds 10 years for underlying prices over (roughly) $2 g⁻¹.

Next the model is applied to the same mine, but with a more complex extraction regime. This particular regime has been created so as to optimize the decision to process ore-bearing tonnage or not, known as cut-off grade optimization. This provides a convenient example where the resulting optimal abandonment surface is two-dimensional, thus requiring to be solved using the Semi-Lagrangian method. FIG. 7I shows the optimal abandonment price throughout the mine, at each quartile of the maximum duration of extraction, t=0, 0.25T, 0.5T and T, where T is now 14.1 years. FIG. 7I uses the same ore-grade data as those of FIG. 7A and the parameter values set out above with reference to FIG. 7A.

By using the abandonment surface of FIG. 71 and the semi-Lagrangian method, Equations (64) and (65) can be solved to give the probability of completion, which is shown in FIG. 7J(lhs), and the expected lifetime of the mine, shown in FIG. 7J(rhs). The results are similar to those previously derived, where most change in the probability occurs over prices below (around) $3 g⁻¹, and above this price the expected lifetime of the mine remains close to the maximum possible duration.

As indicated above, whilst the above method has been described in relation to a valuation dependent upon a single stochastic variable, the method can readily be applied to a valuation dependent upon more than one stochastic variable. For example, where price S and resource grade G are modelled as stochastic variables the two stochastic variable model corresponding to Equation (48) can be determined using the expectation method described above, and a model of probability and expected lifetime can also be determined Numerical schemes generally corresponding to Equation (55) can be derived for the models and solved in the manner described above to provide values of V, P and D for points in a solution space H for the model in which price and grade are modelled as stochastic variables.

The method described above in which a surface of abandonment is determined can be applied to a hysteretic extraction process in which it is possible to move between a first extraction rate qᵢ and a second, higher extraction rate q₂, upon payment of an associated cost. In a similar manner to that described above, surfaces within the solution space are determined A surface, S^{e}(Q, t), indicates prices at which the extraction should be expanded, that is where the current extraction rate is qₗ the costs associated with expanding extraction are outweighed by the increase in the value of the resource. A further surface S^{c}(Q, t), indicates prices at which extraction should be contracted, that is where the current extraction rate is q₂ the costs associated with contracting extraction are outweighed by the effect on the value of the resource.

The surface S^{e}(Q, t) is determined by solving V_{q1}(S, Q, t)=V_{q2}(S, Q, t)−C^{e}, where V_{q1} provides valuations of the mine determined using the numerical scheme of Equation (14) with extraction rate q₁,V_{q2} provides valuations of the mine determined using the numerical scheme of Equation (14) with extraction rate q₂ and C^{e} is the cost associated with expanding extraction. Similarly, the surface S^{e}(Q, t) is determined by solving V_{q2}(S, Q, t)=V_{q1}(S, Q, t)−C^{c}, where V_{q1} and V_{q2} are as described above and C^{c} are the costs associated with contracting extraction. The determined values of S for each of the surfaces indicate the surfaces at which the extraction rate should be changed.

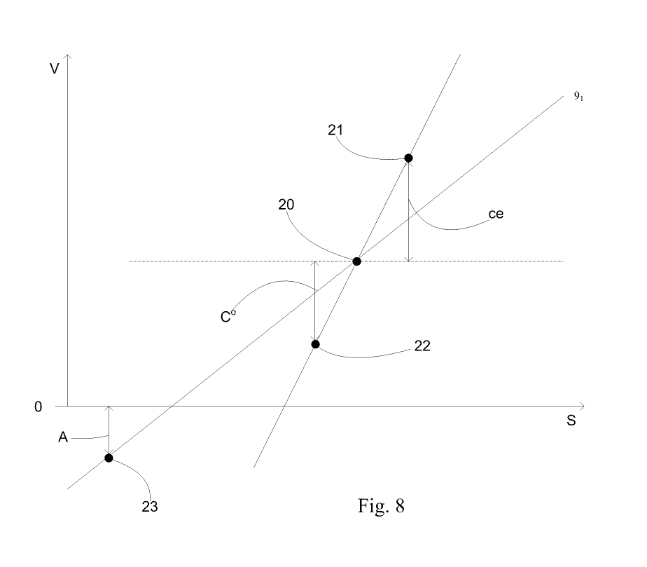

It will be appreciated that expansion and contraction will occur for different values of (S, Q, t). That is, where particular values (S, Q, t) were not sufficient to cause expansion (on the basis that the expansion would not fully cover the cost of expansion, those same values of (S, Q, t) may be sufficient to maintain extraction at the higher rate following expansion on the basis that contraction at that stage is mitigated against by the cost of contraction C^{c}. This can be seen from the simplified illustration of FIG. 8 in which a graph showing variation in the valuation V of the resource with respect to price S for two extraction rates q₁ and q₂. A point 20 is that at which the valuation V is equal for each of the extraction rates q₁ and q₂. However, given the cost associated with expansion C^{e} a change from the extraction rate q₁ to the extraction rate q₂ does not make economic sense at the point 20. A point 21 is that for which the valuation V obtained at the extraction rate q₂ is greater than the valuation V at the extraction rate q₁ by the cost of expansion C^{e}. As such, at the point 21, adopting the extraction rate q₂ makes economic sense on the basis that the cost of expansion is compensated for the increased valuation of the resource.

Similarly, if one is extracting at the higher extraction rate q₂ it does not make economic sense to change extraction rate at the point 21 given the associated cost of contraction C^{c}. However, a point 22 is that at which the valuation associated with the lower extraction rate q₁ is greater than that associated with the higher extraction rate q₂ by the cost of contraction C^{c} meaning that adopting the lower rate of extraction C^{e} makes economic sense.

FIG. 8 further shows a point 23 at which abandonment of the mine makes economic sense on the basis that the negative valuation of the resource is compensated for by the cost of abandonment A.

Whilst it has been described above that two extraction rates are modelled, it will be appreciated that any number of extraction rates can be modelled with the surface indicating the values of price for which extraction rate should be changed between any two adjacent extraction rates determined as described above for extraction rates q₁ and q₂.

A model P, indicating a probability of completion of extraction and a model D indicating an expected lifetime of extraction can be determined for each of the extraction rates q₁ and q₂ as described above with reference to Equations (64) and (65). However it can be noted that the models for extraction rate q₂ will not have an associated surface of abandonment. This is because whilst extraction rate q₁ is applicable for any value of price between the surface of abandonment S*(Q, t), at which point extraction is abandoned, and S^{e}(Q, t) the solution space of the extraction rate q₂ is bounded at the lower end by the surface of contraction S^{c}(Q, t), at which point extraction is contracted such that the extraction rate becomes q₁ and the models for extraction rate q₁ become applicable. As such, determination of a probability of completion of extraction and an expected lifetime of extraction using the models based upon extraction rate q₁ can proceed as set out above, whereas using the models based upon extraction rate q₂ the determination must be modified as will now be described using probability of completion of extraction as example. It will be appreciated that expected lifetime of extraction proceeds in a corresponding manner.

Referring back to the model of probability of completion of extraction of Equation (64) various boundary conditions are described. However, where two extraction rates can be switched between upon price achieving a value on a surface of expansion S^{e}(Q, t) or a surface of contraction S_{c}(Q, t), some of the boundary conditions are different dependent upon the extraction rate modelled. In particular, in the system where two extraction rates q₁ and q₂ are modelled, the far field boundary condition on the lower extraction rate q₁ can no longer be determined by P_{q1}→1 as S→∞, given that S cannot tend to ∞ in this model. Rather, the upper bound on S is the surface of expansion Sₑ(Q, t) and on this surface the probability of completion of extraction P_{q1} tends to the probability of completion of extraction at that price in the model using extraction rate q₂, P_{q2}. That is, the far field boundary condition for the model P_{q1}→P_{q2} on S=S^{e}. Similarly, the lower bound on price for the probability of extraction P_{q2} is no longer the surface of abandonment S* and is rather the surface of contraction S^{c}. As such, the lower boundary condition for P_{q2} is given by P_{q2}→P_{q1} on S=S^{c}.

Given that the solutions for some of the values in the models P_{q1} and P_{q2} depend upon values in the other model, values of P_{q1} and P_{q2} at the boundaries are first estimated in one model and values for the other model are solved using the estimate. The values determined using the estimated values are then provided to the other model to provide a refined solution which replaces the initial estimate. The refined solution can then be provided to the other model until a stopping condition is achieved, for example until the solutions provided by two iterations differ by a small enough amount at each solution point. Alternatively, only those points that lie in a solution space of each of the models P_{q1} and P_{q2} may be checked. That is, at time τ a check may be carried out to determine whether P_{q1}−P_{q2}<δ at S=S^{c} and P_{q2}−P_{q1}<δ at S=S^{e} for all τᵢ in [0, T].

As indicated above, the same method can be carried out to determine values D indicating expected lifetime of extraction. It will be appreciated that where a plurality of different extraction rates are modelled, adjacent extraction rates provide boundary conditions for each other, with a model of an extraction rate qₙ providing a far field boundary condition for a model of an extraction rate qₙ₋₁ and the model of the extraction rate qₙ₋₁ providing a lower boundary condition for the extraction rate qₙ.

It has been described above that either an extraction rate can be modelled as a continuously variable rate to be optimised or as two or more constant extraction rates that can be switched between upon payment of an associated cost. It will be appreciated however that extraction rates with associated costs for switching and continuously variable rates can be modelled in parallel. That is, the constant extraction rate models can be used to determine surfaces at which an extraction rate with upper and lower bounds should be increased upon payment of costs and the models for continuously variable rates can be used to optimally vary the extraction rate within the upper and lower bounds of the extraction rate.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

### APPENDIX 1

To highlight a particular example of the model:

$$\frac{1}{2} {σ}^{2} {S}^{2} \frac{{\partial }^{2} P}{\partial {S}^{2}} - \frac{\partial P}{\partial τ} - q \frac{\partial P}{\partial Q} + μ S \frac{\partial P}{\partial S} = 0$$

which acts as a convenient approximation to the exact probability of completion, we shall derive a closed-form solution under two simplifying, but reasonable, assumptions. These are that the position of abandonment, S*, is fixed, and the extraction rate, q, is a known function of time up until abandonment. This second simplification implies that Q is also a specified function of time until abandonment, and we therefore do not need to consider Q as an independent variable when solving away from the abandonment barrier. In making these two simplifications we are, in effect, collapsing the problem to a much simpler one; namely, what is the probability of a particle obeying the motion of equation (1) hitting a level barrier by a certain time? Since this particle problem has a well-known solution, these simplifications act as a methodology check on numerical solutions.

With these assumptions, we may seek a solution to equation (64) of the form

P=1+\hat{P}(τ, S) (A1)

which, when coupled with a substitution for S of the form

$$Y = log ( \frac{S}{{S}^{*}} ) \qquad ( A 2 )$$

transforms equation (64) into

$$\frac{1}{2} {σ}^{2} \frac{{\partial }^{2} \hat{P}}{\partial {Y}^{2}} - \frac{\partial \hat{P}}{\partial τ} + ( r - δ - \frac{1}{2} {σ}^{2} ) \frac{\partial \hat{P}}{\partial Y} = 0 \qquad ( A3 )$$

This is subject to the transformed boundary conditions

$$and \begin{matrix}\hat{P} = - 1 on Y = 0 \\ \hat{P} -> 0 as Y -> ∞ \\ \hat{P} = 0 on τ = 0\end{matrix} \} \qquad ( A4 )$$

The form of this equation allows us to reduce it to the well-known heat equation. We achieve this by making the transformation

\hat{P}=e^{αY+βτ}g(Y, τ) (A5)

and setting

$$α = \frac{1}{2} - \frac{( r - δ )}{{σ}^{2}} and β = - \frac{{σ}^{2}}{2} {( \frac{1}{2} - \frac{( r - δ )}{{σ}^{2}} )}^{2} \qquad ( A6 )$$

which removes terms in g and ∂g/∂Y, respectively, allowing us to write

$$\begin{matrix}\frac{1}{2} {σ}^{2} \frac{{\partial }^{2} g}{\partial {Y}^{2}} = \frac{\partial g}{\partial τ} \\ subject to & ( A7 ) \\ and \begin{matrix}g = - {e}^{- βτ} on Y = 0 \\ g -> 0 as Y -> ∞ \\ g = 0 on τ = 0\end{matrix} \} & ( A8 )\end{matrix}$$

This equation is simply the heat equation subject to homogeneous initial conditions and a non-homogeneous Dirichlet boundary condition. As such, we can now use the standard result (Cannon 1984) to write

$$g ( Y , T ) = - {\int }_{0}^{T} \frac{Y}{2 {{πσ}^{2} ( T - z )}^{3}} exp ( - \frac{{Y}^{2}}{2 {σ}^{2} ( T - z )} - β z ) d z \qquad ( A9 )$$

This exact solution to equation (A7) means that we can therefore write the probability of the mine remaining open until expiry as

$$P = 1 + {e}^{α Y + β T} g ( log ( \frac{S}{{S}^{*}} ) , T ) \qquad ( A10 )$$

where g is given by equation (A9). This can more conveniently be written as

$$P = 1 - {\int }_{0}^{T} \frac{log ( S ) - log ( {S}^{*} )}{2 {πσ}^{2} {z}^{3}} exp ( - \frac{{( log ( S ) - log ( {S}^{*} ) - {σ}^{2} α z )}^{2}}{2 {σ}^{2} z} ) d z \qquad ( A11 )$$

and is a known result from first passage problems, typically solved using probabilistic methods (Rogers & Williams 2000).

A similar approach can be taken towards deriving the expected lifetime, D, from equation (65). This time we seek a solution of the form

D=T+\hat{D}(τ, S) (A12)

and then follow exactly the same approach as previously to derive the result

$$D = T - {\int }_{0}^{T} \frac{( log ( S ) - log ( {S}^{*} ) ) ( T - z )}{2 π {σ}^{2} {z}^{3}} exp ( - \frac{{( log ( S ) - log ( {S}^{*} ) - {σ}^{2} α z )}^{2}}{2 {σ}^{2} z} ) d z \qquad ( A13 )$$

With these exact forms now derived, we can compare their behaviours with those of the numerically derived solutions, which can handle a variable surface of abandonment.

1. A computer-implemented method of valuing a resource using a computer comprising a processor and a memory storing processor readable instructions, the method comprising:
storing in the memory a model representing a relationship between the economic value of the resource, a rate of extraction of the resource and a parameter indicative of a property of the resource;
processing, by the processor, the model to generate an economic value of the resource, the model;
wherein the model stored in the memory and processed by the processor represents variation of the property of the resource with respect to a parameter based upon a quantity of the resource.

2. A method according to claim 1, wherein the property is indicative of a grade of the resource and wherein the grade is a proportion of the resource in a unit of extracted material.

3. A method according to claim 1, wherein the property of the resource is a stochastic property which generally follows a mean reverting process.

4. A method according to claim 1, wherein the parameter based upon a quantity of the resource is the rate of extraction.

5. A method according to claim 1, wherein the model comprises a parameter indicative of the economic value associated with the resource and a parameter indicative of the rate of extraction, and wherein each of the parameters is deterministic.

6. A method according to claim 1, wherein the model further represents a relationship between the economic value associated with the resource and a parameter indicative of a price of the resource.

7. A method according to claim 1, further comprising processing the model to generate a value of the rate of extraction which optimises the economic value of the resource.

8. A method according to claim 1, wherein the resource is a natural resource and wherein the rate of extraction is a rate of removal from a natural reserve and wherein the rate of extraction is controllable.

9. A computer program comprising computer readable instructions configured to cause a computer to carry out a method according to claim 1.

10. A computer apparatus valuing a resource comprising:
a memory storing processor readable instructions; and
a processor arranged to read and execute instructions stored in the memory;
wherein the processor readable instructions comprise instructions arranged to control the computer to carry out a method according to claim 1.

11. A computer-implemented method of determining an optimal extraction rate of a resource using a computer, the computer comprising a processor and a memory storing processor readable instructions, the optimal extraction rate being associated with an optimal economic value of the resource, the method comprising:
storing in the memory a model representing a relationship between an economic value of the resource, an extraction rate and at least one stochastic variable;
storing in the memory a control equation, the control equation being based upon the model; and
iteratively determining, by the processor, the optimal extraction rate and the optimal economic value by determining values for parameters of the model representing the economic value of the resource and the extraction rate which satisfy the model and the control equation.

12. A method according to claim 11, wherein the resource is a natural resource and wherein the rate of extraction is a rate of removal from a natural reserve and wherein the rate of extraction is controllable.

13. A computer program comprising computer readable instructions configured to cause a computer to carry out a method according to claim 11.

14. A computer apparatus valuing a resource comprising:
a memory storing processor readable instructions; and
a processor arranged to read and execute instructions stored in the memory;
wherein the processor readable instructions comprise instructions arranged to control the computer to carry out a method according to claim 11.

15. A computer-implemented method of valuing a resource using a computer comprising a memory and a processor, the method comprising:
generating, by the processor, a model representing a relationship between an economic value of the resource and three stochastic variables and storing the model in the memory; and
deriving, by the processor, the value of the economic value of the resource based upon the model.

16. A method according to claim 15, wherein the three stochastic variables are selected from the group consisting of: a grade associated with the resource; a price associated with the resource; a convenience yield associated with the resource; and an interest rate associated with the resource.

17. A method according to claim 15, wherein the method further comprises:
deriving a value associated with an extraction rate of the resource;
wherein the value associated with an extraction rate of the resource is a value providing an optimal value of the economic value of the resource.

18. A computer-implemented method of selecting an extraction rate for a resource using a computer comprising a memory and a processor, the method comprising:
storing in the memory a model;
processing, by the processor, said model to generate a first economic value of the resource based upon a first extraction rate;
processing, by the processor, data indicating a second economic value associated with a second extraction rate; and
selecting one of said first extraction rate and said second extraction rate based upon said first economic value and said second economic value.

19. A method according to claim 18, wherein the second extraction rate is zero.

20. A method according to claim 18, wherein said second economic value is generated by processing a model based upon said second extraction rate.

21. A method according claim 18, wherein each of said first and second extraction rates are non-zero extraction rates and further comprising processing data indicating a third economic value associated with a third extraction rate, said third extraction rate being zero.

22. A method according to claim 18, wherein selection of one of said first extraction rate and said second extraction rate is based upon a current extraction rate and a cost associated with changing the extraction rate and wherein a first cost is associated with a change of extraction rate from said first extraction rate to said second extraction rate and a second different cost is associated with a change of extraction rate from said second extraction rate to said first extraction rate.

23. A method according to claim 18 wherein said model models one or more parameters selected from the group consisting of: price, resource grade, resource quantity, and time.

24. A computer-implemented method for determining whether to extract a resource based upon a model modelling resource value using a computer, the computer comprising a memory and a processor, the method comprising:
storing in said memory said model modelling resource value;
determining, by said processor, values of parameters of said model for which extraction of the resource is not economically viable wherein said determining is based upon a cost associated with abandonment of the resource;
processing, by the processor, current values for said parameters of said model to determine whether to extract the resource.

25. A computer-implemented method for predicting values of parameters indicative of desirability of future extraction of a resource using a computer, the computer comprising a memory and a processor, the method comprising:
storing in said memory a model;
determining, by said processor, values of parameters of said model for which extraction of the resource is not economically viable;
modelling, by said processor, likely variation of at least some of said parameters to generate a prediction of at least one of a time for which future extraction is desirable, a probability that the resource extraction will complete, a time at which extraction is expected to be contracted and a time at which extraction is expected to be expanded.

26. A computer-implemented method for predicting values of variables associated with extraction of a resource using a computer, the computer comprising a memory and a processor, the method comprising:
storing in said memory a generic model representing variation in value of a generic variable in terms of variation of a plurality of variables;
processing, by said processor, said model to generate a plurality of specific models, each associated with a specific variable, each specific model modelling variation in value of a specific one of said variables associated with extraction of said resource in terms of variation of the plurality of variables;
determining, by said processor, values for a first one of said specific variables based upon a respective one of said specific models; and
using said determined values to determine, by said processor, values for others of said specific variables based upon respective ones of said specific models.

27. A method according to claim 26, wherein processing said model to generate a plurality of specific models, each associated with a specific variable, comprises applying conditions to said generic model.

28. A method according to claim 26, wherein said first one of said specific variables is a variable indicating a valuation of the resource.

29. A method according to claim 26, wherein using said determined values to determine values for others of said specific variables comprises determining a boundary condition for said respective ones of said specific models modelling said others of said specific variables, wherein said boundary condition is defined by values for one or more of said plurality of variables at which extraction of said resource is abandoned.

30. A method according to claim 26, wherein said others of said specific variables are at least one of a time for which future extraction is desirable and a probability that the resource extraction will complete.
